(19) United States
(12) Patent Application Publication
(10) Pub. No.: US 2022/0169753 A1
(43) Pub. Date: Jun. 2, 2022

(54) AN IMPROVED PROCESS FOR PREPARATION OF SUGAMMADEX ACID AND SUGAMMADEX SODIUM

(71) Applicant: HOSPIRA, INC., Lake Forest, IL (US)

(72) Inventors: Bhuvaneswari Sridhar, Chennai, Tamil Nadu (IN); Jaya Satyanarayana Kudavalli, Chennai, Tamil Nadu (IN); PeterPaul Raju Medabalimi, Chennai, Tamil Nadu (IN); Naga Mallesh Remala, Hyderabad, Telangana (IN); Suresh Devineni, Khammam, Telangana (IN); Gururaj Ramachandran, Channai, Tamil Nadu (IN); Thanneerpandalpudur Srinivasan Jaganathan, Chennai, Tamil Nadu (IN); Karthikeyan Kaliaperumal, Kancheepuram, Tamil Nadu (IN)

(73) Assignee: HOSPIRA, INC., Lake Forest, IL (US)

(21) Appl. No.: 17/599,079

(22) PCT Filed: Mar. 25, 2020
(86) PCT No.: PCT/IB2020/052816

§ 371 Date: Sep. 28, 2021

Related U.S. Application Data
(60) Provisional application No. 62/826,559, filed on Mar. 29, 2019.

(51) Int. Cl. C08B 37/16

(52) U.S. Cl. CPC C08B 37/0012

(57) ABSTRACT

The present disclosure provides an improved process for the synthesis of suganmmadex acid and suganmmadex sodium.

### FIELD OF THE INVENTION

The present invention relates to an industrially viable and cost-effective process for manufacturing sugammadex sodium.

### BACKGROUND OF THE INVENTION

Sugammadex sodium (designation Org 25969, trade name Bridion) is an agent for reversal of neuromuscular blockade induced by neuromuscular blocking agents (NMBA), such as rocuronium bromide and vecuronium bromide in general anesthesia. Sugammadex sodium is anionic gamma cyclodextrin containing a hydrophilic exterior and a hydrophobic core. Sugammadex sodium is a selective relaxant binding agent (SRBA) which forms inclusion complexes with neuromuscular binding agents. The gamma cyclodextrin has been modified from its natural state by placing eight carboxyl thioether groups at the sixth carbon positions.

The binding of the NMBA to sugammadex sodium occurs because of van der Waals forces, hydrophobic and electrostatic interactions. The structure of sugammadex sodium is such that the NMBA fits tightly into sugammadex sodium forming an inclusion complex. The negatively charged sugammadex attracts the positively charged moiety of the NMBA to form a complex (FIG. 1). Therefore, the neuromuscular blockade of NMBA such as rocuronium is terminated rapidly.

Sugammadex sodium is a modified gamma cyclodextrin (cyclic octamer of glucose) with every sixth carbon hydroxyl group substituted with a thioether linked to a propionate group (eight side chains added). Sugammadex sodium contains 8 recurring glucose units each with 5 asymmetric carbon atoms, in total 40 asymmetric carbon atoms for the whole molecule. Sugammadex sodium has a lipophilic core and a hydrophilic periphery.

The structure of sugammadex sodium is as shown in below formula:

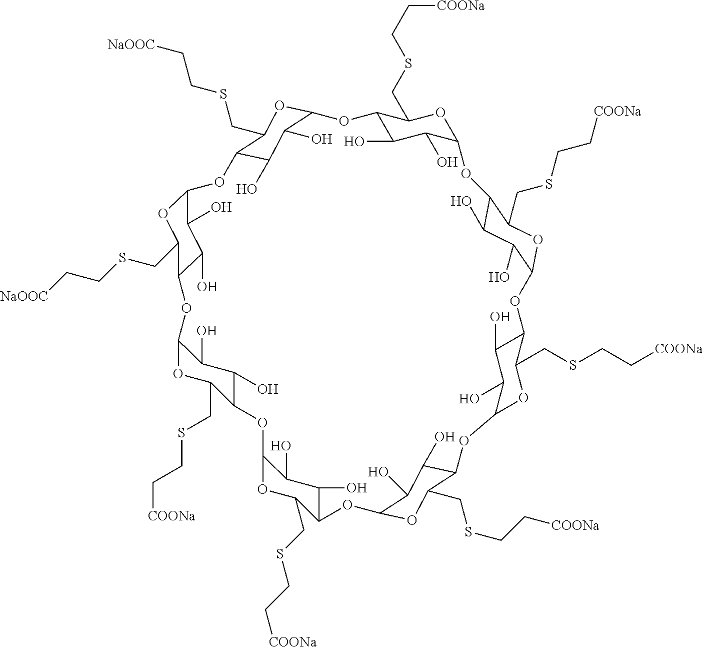

Process conditions to prepare sugammadex sodium significantly impact the structure and associated properties of the molecule prepared therefrom. For example, the process conditions can alter the average degree of substitution, the distribution of substitution, the regiochemistry of substitution (i.e., the substitution pattern), and combinations thereof. Process conditions that can be controlled and varied include reaction time, pH, rate of agitation, temperature, stoichiometry, concentration, and the like. The processes to prepare sugammadex sodium can be costly, time-consuming, or require significant purification due to, e.g., the breakdown of reagents and the formation of multiple side products.

U.S. Pat. No. 6,670,340 refers to a two-step process for preparing sugammadex sodium as depicted in Scheme 1.

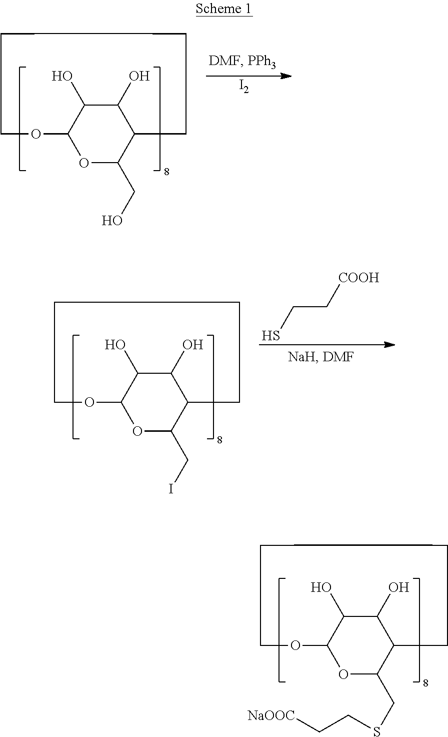

The U.S. Pat. No. 6,670,340 process involves iodination of gamma cyclodextrin using iodine and triphenylphosphine to get 6-perdeoxy-6-periodo gamma cyclodextrin. The 6-per-deoxy-6-per-iodo-gamma cyclodextrin (Step I) is reacted with 3-mercapto propionic acid in dimethylformamide (DMF) and sodium hydride under nitrogen atmosphere at 70° C. for 12 hours and on dialysis for 36 hours to give sugammadex sodium. The process referred to in U.S. Pat. No. 6,670,340 suffers from the following disadvantages:
(i) In the first step of this process, addition of iodine to the reaction mass is highly exothermic, and the usage of iodine in the scale up would be difficult.
(ii) In the second step, sodium hydride, used as the base, is not advisable because of its scale up difficulties and resultant degradation of the product, leading to a poor quality of the drug substance.
(iii) Dialysis is used for purification of sugammadex sodium. The dialysis purification technique is not advisable in commercial manufacture and the product does not meet the quality.

Accordingly, the process as disclosed in U.S. Pat. No. 6,670,340 is lengthy and not feasible on commercial scale.

WO2012/025937 refers to a synthesis of sugammadex sodium involving the use of phosphorus pentachloride (PCl₅) as depicted in Scheme 2. In this process, gamma cyclodextrin is chlorinated using phosphorus pentachloride to get 6-perdeoxy-6-perchloro gamma cyclodextrin which is converted into sugammadex sodium using reaction with 3-mercaptopropionic acid in presence of sodium hydride and DMF

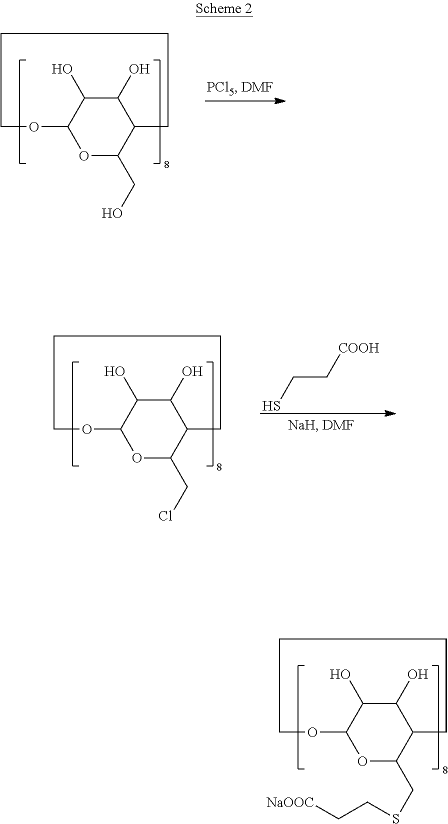

The process in WO2012/025937A1 suffers from the following disadvantages:
(i) The halogenating agent, which is prepared by reaction of phosphorous pentachloride and dimethylformamide, produces numerous phosphorous species on reaction with dimethylformamide, and its subsequent use for the halogenation of gamma cyclodextrin also produces phosphate esters as impurities which are difficult to remove.
(ii) The removal of dimethylformamide after chlorination of gamma cyclodextrin gives highly viscous oil, which is very cumbersome to stir.
(iii) The purity and yield of 6-perdeoxy-6-perchloro gamma are also very low.
(iv) The chlorination of gamma cyclodextrin with a strong chlorinating agent like PCl₅ may result in formation of multiple by-products. Instead of the desired chlorination of the 6^{th} carbon which is primary hydroxy group, the 3^{rd} and 4^{th} secondary hydroxy groups can also be chlorinated to give impurities.
(v) The procedure requires the utilization of chromatographic techniques for purification of the crude sugammadex, which are costly and hard to implement in the industrial production scale.
(vi) The use of pyrophoric sodium hydride is also not recommended as it forms explosive hydrogen gas, involves addition of mineral oil to the reaction mixture and is also associated with extensive foaming.
(vii) The reaction time of 6-perdeoxy-6-perchloro gamma cyclodextrin with 3-mercaptopropionic acid is also high (about 12 hours).

WO2014/125501 refers to the preparation of sugammadex by following the process as set forth in WO2012/025937. The process of WO2014/125501 involves reacting phosphrous pentachloride (PCl₅) with DMF. In this process gamma cyclodextrin was added to yield 6-perdeoxy-6-per-chloro gamma cyclodextrin. The 6-perdeoxy-6-per-chloro gamma cyclodextrin was then reacted with 3-mercapto propionic acid in DMF to obtain crude sugammadex. The sugammadex crude was purified using a mixture of water methanol to obtain pure sugammadex sodium.

In addition to the issues (i), (iii) and (vii) described above for the WO 2012/025937A1 process, the process in WO2014/125501 suffers from the following:
(i) The filtration of 6-perdeoxy-6-perchloro gamma cyclodextrin is very challenging as it takes a very long time for the filtration due to its amorphous nature.
(ii) The process requires anhydrous conditions, because trace moisture in the reaction product can lead to a mixture of 7-substituted and/or 6-substituted impurities.

WO2016/194001 refers to the preparation of sugammadex sodium by the process as depicted in Scheme 3. This process involves chlorination of gamma cyclodextrin using triphosgene/oxalyl chloride. The intermediate then was reacted with 3-Mercaptopropionic acid in presence of bases like sodamide/potassium hydroxide, and was acidified using hydrochloric acid to prepare sugammadex free acid. The sugammadex free acid was subsequently converted into sugammadex sodium by reaction with sodium hydroxide.

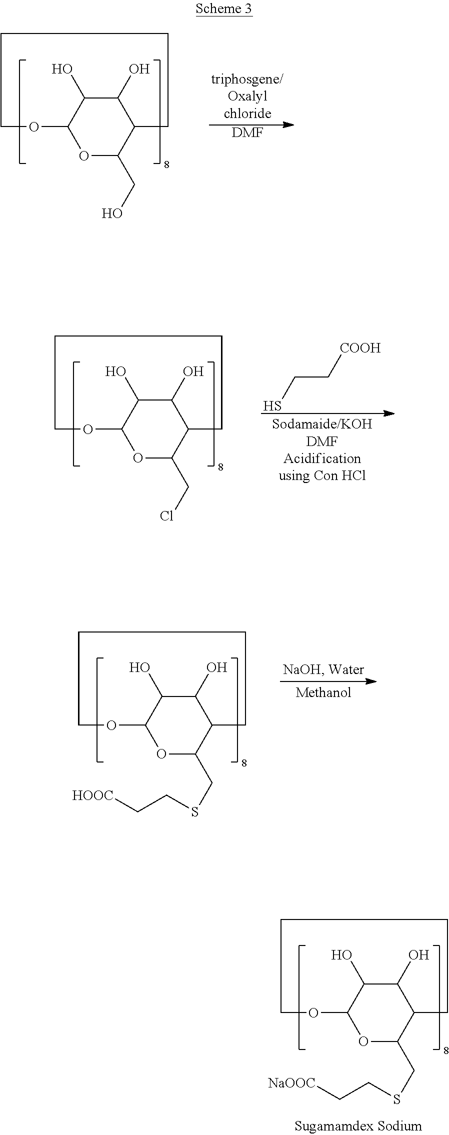

The process in WO2016/194001 suffers from the following disadvantages:
(i) The process uses a highly unstable hazardous compound triphosgene and a corrosive molecule oxalyl chloride.
(ii) The process involves using sodamide which is a highly unsafe for use in large scale operations.
(iii) The procedure requires the utilization of chromatographic techniques for purification of the crude sugammadex; which are costly and hard to implement in commercial scale.

WO2017/089966 refers to the preparation of sugammadex and certain intermediates. It indicates various polymorphic forms of 6-perdeoxy-6-perchloro gamma cyclodextrin and claims a crystalline polymorphic form of an intermediate that was prepared using oxalyl chloride/thionyl chloride followed by purification by water:alcoholic solvent. In the next step, sodium hydride in DMF and sodium tert-butoxide in dimethylsulphoxide (DMSO) were used for the preparation of sugammadex sodium. (Scheme 4)

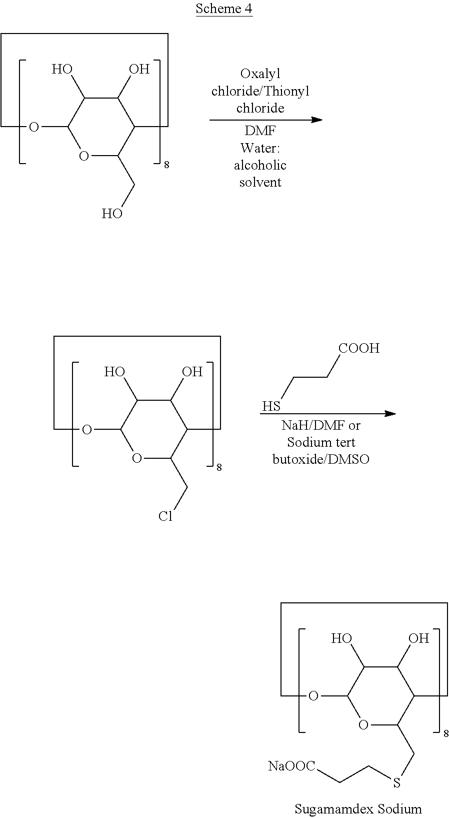

The process in WO2017/089966 suffers from the following disadvantages:
(i) The process is not cost effective because it involves ultrafiltration, column purification and lyophilization techniques in the purification process.
(ii) There are no information disclosed on the yield and quality of sugammadex sodium prepared with the process.

WO2017/0144734 refers to the preparation of sugammadex and certain of its intermediates. In the first step, 6-perdeoxy-6-perbromo gamma cyclodextrin was prepared by reacting gamma cyclodextrin with Vilsmeier-Haack reagent (which is prepared from bromine and triphenyl phoshine) in presence of DMF. In the next step, 3 to 7 Molar sodium hydroxide solution and DMSO were used to obtain sugammadex sodium (Scheme 5).

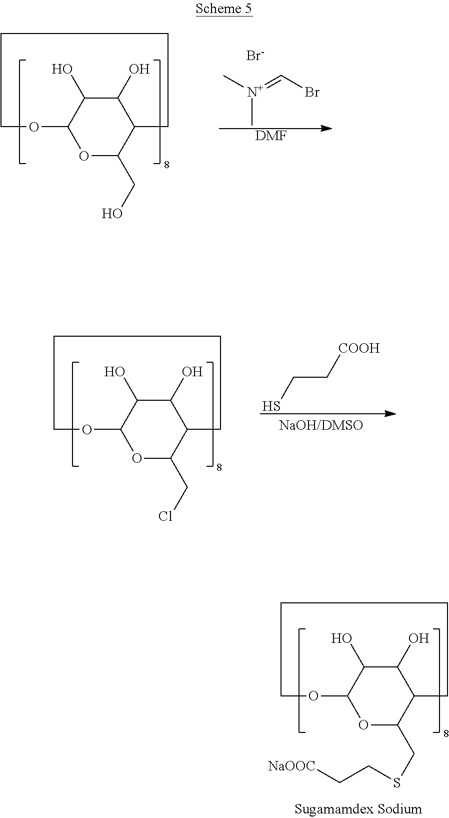

The process in WO2017/0144734 suffers from the following disadvantage:
(i) Highly hazardous bromine and DMSO are used.
(ii) Such hazardous reagents are not convenient in larger scale operations.

In summary, the existing procedures for the preparation of sugammadex sodium suffer from one or more of the following disadvantages:
(i) Because sugammadex sodium is a highly complex molecule, the process of preparing sugammadex sodium could result in a high impurity formation. Most of these impurities have identical structures, and hence physio-chemical properties and solubility profiles of these impurities are similar to that of the active substance, sugammadex sodium. Therefore, removing impurities from the active substance is challenging and may require multiple purification steps;
(ii) High content of impurities are formed. Generally the product with high content of impurities is not accepted by pharmaceutical regulatory agencies for marketing;
(iii) Despite multiple rounds of purification steps, the crude sugammadex sodium has a high content of impurities;
(iv) The reagents employed produce unwanted impurities in higher level as byproducts. Examples of impurities include oxidation impurities, such as sulphoxide diastereomers, sugammadex disulfide, sugammadex methyl ester, monochloro sugammadex, and dihydroxy sugammadex;
(v) The process results in a highly viscous reaction mixture of 6-per-deoxy-6-per-chloro-gamma cyclodextrin which is very difficult to handle;
(vi) The filtration of 6-per-deoxy-6-per-chloro-gamma cyclodextrin is also very challenging due to its amorphous nature;
(vii) The purification techniques employ column chromatography, ultra-filtration and/or membrane dialysis techniques which are associated with high costs in commercial practice;
(viii) Due to the longer time duration, handling of reaction and multiple purifications for the removal of impurities are not desirable for the preparation of sugammadex sodium and its intermediates in the processes;
(ix) Various hazardous and corrosive chemicals which are not convenient in larger scale operations are involved;
(x) The second step involves dimethylformamide and/or dimethylsulphoxide which results in impurity formation;
(xi) The processes for preparation of sugammadex sodium are time consuming and not economically and industrially viable;
(xii) Impurities in sugammadex sodium are formed because of incomplete substitution, partial substitution, oxidation, intra-substitution and epimerization, and degradation (due to the exposure to light, air and moisture); and/or
(xiii) Use of sodium hydroxide and demineralized (DM) water for the preparation of sugammadex sodium results in highly basic medium like sodium hydroxide. The use of alcoholic solvent to precipitate the sugammadex sodium may form ester impurities.

Thus, there exists a need for an improved and efficient process for the preparation of sugammadex sodium.

### OBJECT OF THE INVENTION

An object of the present invention is to provide a process for preparation of sugammadex sodium.

Another object of the present invention is to provide an improved industrially viable and cost effective process for the preparation of sugammadex sodium.

Another object of the present invention is to provide an improved process for the preparation of sugammadex sodium with good yield and high purity.

Another object of the present invention is to provide a process for the preparation of sugammadex sodium which eliminates additional steps to remove unwanted impurities by controlling the impurities during the reaction.

Another object of the present invention is to provide a simple process for preparation of sugammadex sodium which involves use of reagents which are conveniently used at industrial scale.

### SUMMARY OF THE INVENTION

The invention provides an improved and economically efficient process for the preparation of sugammadex sodium.

In one aspect, the invention provides an improved process for preparing sugammadex acid of Formula III comprising the steps of:
a. Providing a solution comprising a compound of Formula I and an organic solvent;

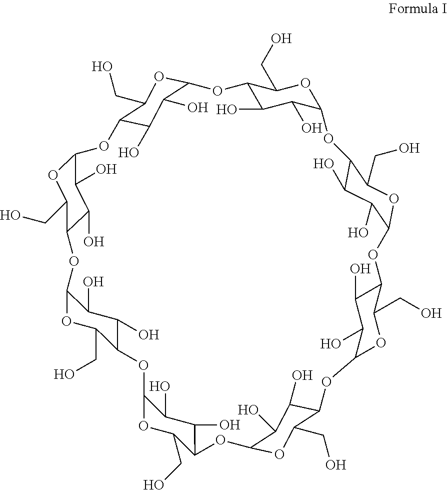 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O]

b. Reacting the solution of step (a) with a halogenating agent and triphenylphosphine to obtain a compound of Formula II,

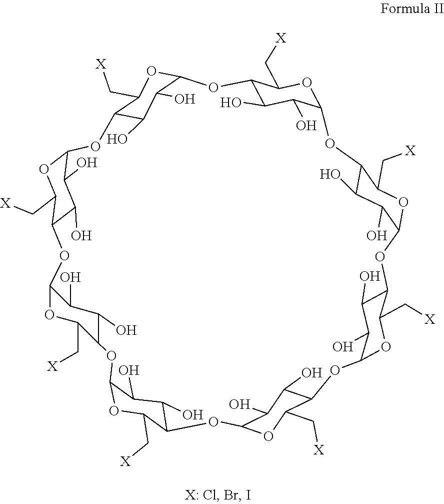

wherein X is a halo; and
c. Reacting the compound of Formula II with 3-mercaptopropionic acid in the presence of an organic solvent, an inorganic base, and water followed by acidification to obtain a compound of Formula III.

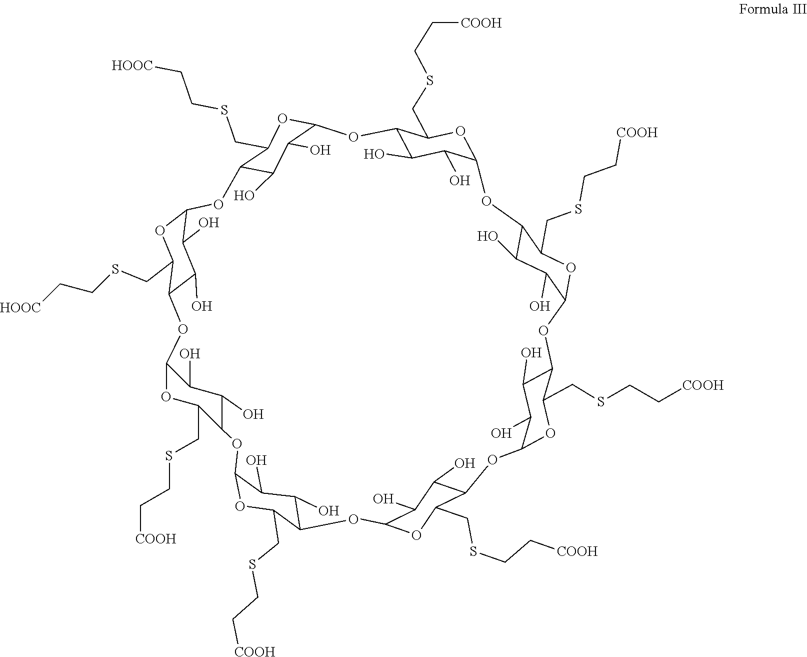 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

In a further aspect, the invention provides an additional step of treating the compound of Formula III using known methods to form a compound of Formula IV (in other words, to obtain sugammadex sodium from a compound of Formula III). In another aspect, the invention provides a process further comprising, treating the compound of Formula III with a sodium exchange agent in presence of water to form a compound of Formula IV.

### BRIEF DESCRIPTION OF FIGURES/DRAWINGS

FIG. 1 is an illustration of an inclusion complex of sugammadex sodium with NMBA such as rocuronium.

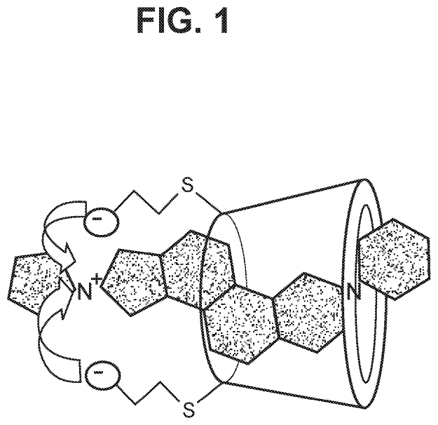

FIG. 2 is an illustration of HPLC chromatogram of sugammadex sodium as prepared following the procedure described in Example 13.

FIG. 3 is an illustration of HPLC chromatogram for chloro gamma cyclodextrin (6-perdeoxy-6-chloro gamma cyclodextrin) as prepared following the procedure described in Example 8.

### DETAILED DESCRIPTION OF THE INVENTION

Detailed embodiments of the present invention are disclosed herein below. However, it is to be understood that the disclosed embodiments are merely exemplary of the invention, which can be embodied in various forms. The scope of the invention is not limited to the disclosed embodiments, and terms and phrases used herein are not intended to be limiting but rather to provide an understandable description of the invention. The invention is defined by claims appended hereto.

### Definitions

The abbreviations used in the present application are defined as following: DMF; dimethylformamide.

DMSO: dimethyl sulfoxide.
DMAc: dimethylacetamide.
MDC: methylene dichloride.
IPA: isopropyl alcohol.

The following definitions are used in connection with the present application unless the context indicates otherwise.

“A” or “an” entity as used herein refers to one or more of that entity; for example, a compound refers to one or more compounds or at least one compound. As such, the terms “a” (or “an”), “one or more”, and “at least one” can be used interchangeably herein.

In the following examples which are provided for illustrative purposes only, all temperatures are in degrees Celsius (° C.) unless otherwise noted. As used herein, the term “room temperature” refers to a temperature from about 18° C. to about 35° C. or a temperature from about 20° C. to about 30° C. or a temperature at about 26° C.

As used herein, the terms “about,” “general,” “generally,” and the like are to be construed as modifying a term or value such that it is not an absolute. Such terms will be defined by the circumstances and the terms that they modify as those terms are understood by those of skill in the art. This includes, at the very least, the degree of expected experimental error, technique error and instrument error for a given technique used to measure a value.

As used herein, the term “comprising” or “comprises” refers to the elements recited, or their equivalence in structure or function, plus any other element or elements which are not recited. The term “having” or “including” is also to be construed as open ended.

As used herein, all ranges recited herein include the endpoints, including those that recite a range between two values. Whether so indicated or not, all values recited herein are approximate as defined by the circumstances, including the degree of expected experimental error, technique error, and instrument error for a given technique used to measure a value.

As used herein, the term “optional” or “optionally” a) means the event or circumstance described in the specification to which the term applies may or may not occur, and b) includes both instances where the event occurs and instances where it does not.

As used herein, all references to spatial descriptions (e.g., “above,” “below,” “up,” “down,” “top,” “bottom,” etc.) made herein are for purposes of description and illustration only, and should be interpreted as non-limiting upon the compositions, formulations, and methods of making and using the same, which can be spatially arranged in any orientation or manner.

As used herein, the term “equivalence” refers to mole ratio of a compound with respect to the main component of the reaction mixture.

As used herein, the term “V” refers to “volumes”, i.e., number of times of an added substance (compound, gas, solid or liquid) relative to the amount of the mixture to which said substance is added. As an example, “10 V toluene” means, 10 times of toluene with respect to gamma cyclodextrin (10×25=250 mL of toluene) when mixed with 1 mole (25.0 grams) gamma cyclodextrin.

As used herein, the term “purity” refers to the amount of a compound in a sample. It is typically determined by the area percentage under the peak of the compound relative to the total area of the sample in the HPLC chromatogram.

Typically the composition of the present invention contains a buffer. The term “buffer” refers to a pharmaceutically acceptable excipient that helps to maintain the pH of the solution within a particular range specific to the buffering system. Non-limiting illustrative examples of pharmaceutically acceptable buffering agents include phosphates, ascorbates, acetates, citrates, tartrates, lactates, succinates, amino acids, maleates, disodium hydrogen orthophosphate, citric acid or combinations thereof.

As used herein, the term “anti-solvent” refers to a liquid that, when combined with a solution of sugammadex, reduces solubility of the sugammadex in the solution, causing crystallization or precipitation in some instances spontaneously, and in other instances with additional steps, such as seeding, cooling, scratching, and/or concentrating.

As used herein, the term “halo” means halogen. The term “6-per-deoxy-6-per-halo gamma cyclodextrin” means a perhalogenated gamma cyclodextrin wherein the halo is chloro, bromo or iodo. The term “6-per-deoxy-6-per-chloro gamma cyclodextrin” means a perhalogenated gamma cyclodextrin wherein the halo is chloride.

As used herein, the term “distillation” refers to a distillation process done at a pressure of no more than about 760 mm Hg.

As used herein, the term “acid” refers to a substance comprising of molecules of ions which donate protons (H+). These include both inorganic acids such as sulfuric, nitric, hydrofluoric, hydrochloric and phosphoric acid and organic acids such as citric, acetic, formic, benzoic, salicyclic, oxalic, glycolic, lactic, glutaric acid, and carbonic acid. The term “base” refers to a substance which accepts protons.

As used herein, the term “acidifying” or “acidification” refers to neutralizing bases present in a reaction mixture or a solution by adding an acid. Acids suitable for neutralizing a reaction mixture are chosen according to the base and a product present in a reaction mixture.

As used herein, the “azeotrope” refers to a liquid mixture of at least two components that boils at constant temperature without change in composition. The temperature at which the azeotrope boils differs from the boiling points of its individual components.

As used herein, the term “azeotropic distillation” refers to the removal of residual solvent from the reaction mixture using a second solvent, wherein the second solvent forms an azeotrope with at least one of the residual solvents and removes the azeotrope from the reaction mixture.

The term “compound of Formula I” refers to gamma cyclodextrin having the formula:

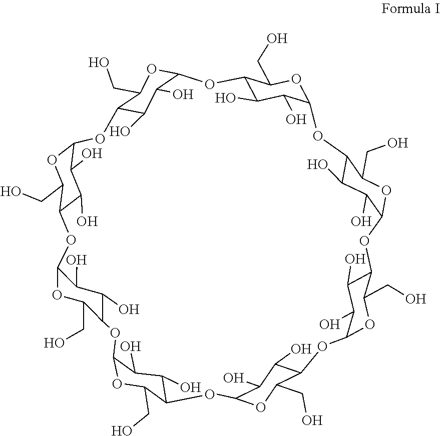 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O]

The term “compound of Formula II” refers to 6-perdeoxy-6-halo gamma cyclodextrin having the formula:

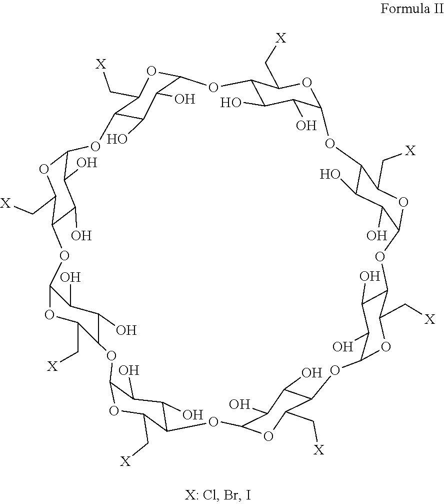

The term “compound of Formula II-a” refers to 6-perdeoxy-6-halo gamma cyclodextrin where X is chloro (6-perdeoxy-6-chloro gamma cyclodextrin). The term “compound of Formula II-b” refers to 6-perdeoxy-6-halo gamma cyclodextrin where X is bromo (6-perdeoxy-6-bromo gamma cyclodextrin). The term “compound of Formula II-c” refers to 6-perdeoxy-6-halo gamma cyclodextrin where X is iodo (6-perdeoxy-6-iodo gamma cyclodextrin).

The term “compound of Formula III” refers to 6-perdeoxy-6-per (2-carboxy ethyl) thio-gamma-cyclodextrin (or “sugammadex acid”) having the formula:

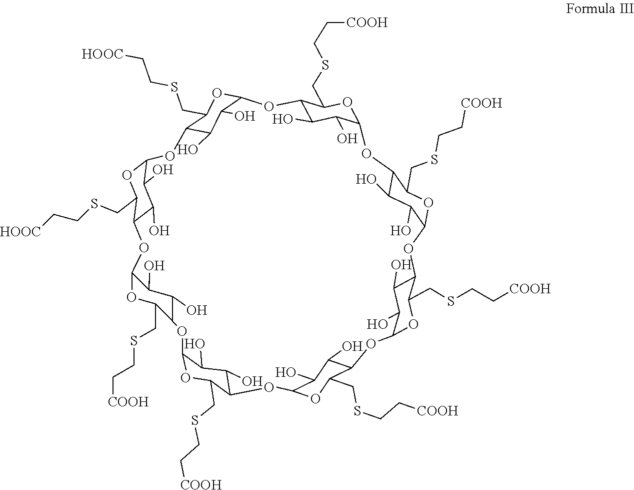 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

The term “compound of Formula IV” refers to 6-perdeoxy-6-per (2-carboxy ethyl) thio-gamma-cyclodextrin sodium (also referred to as “sugammadex sodium”) having the formula:

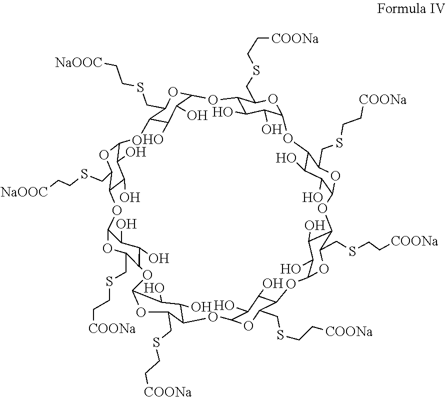

One advantage of the present invention is to provide simple processes for preparation of sugammadex acid and sugammadex sodium which involve use of raw materials and chemicals which are commercially available and conveniently used at industrial scale. Another advantage of the present invention is that the reactions are conducted at nominal temperature of 50 to 55° C. for a shorter duration.

Yet another advantage of the present invention is using simple purification techniques like crystallization in solvent combinations, thereby eliminating the need for using additional steps such as dialysis, ultra-filtration and/or chromatographic techniques, as needed in existing processes. A further advantage of the present process is generating highly pure sugammadex sodium, i.e., more than 99% by HPLC, when compared to prior art samples which are at 95% pure by HPLC.

In one aspect, the invention provides a process for preparing sugammadex acid of Formula III comprising the steps of:
a. Providing a solution comprising a compound of Formula I and an organic solvent;

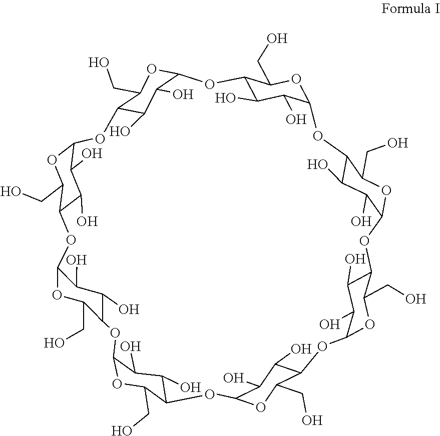 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O]

b. Reacting the solution of step (a) with a halogenating agent and an organophosphorus compound such as triphenylphosphine to obtain a compound of Formula II,

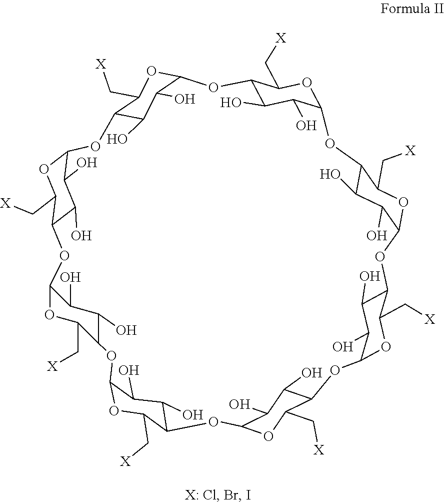

wherein X is a halo; and
c. Reacting the compound of Formula II with 3-mercaptopropionic acid in the presence of an organic solvent, an inorganic base, and water followed by acidification to obtain a compound of Formula III.

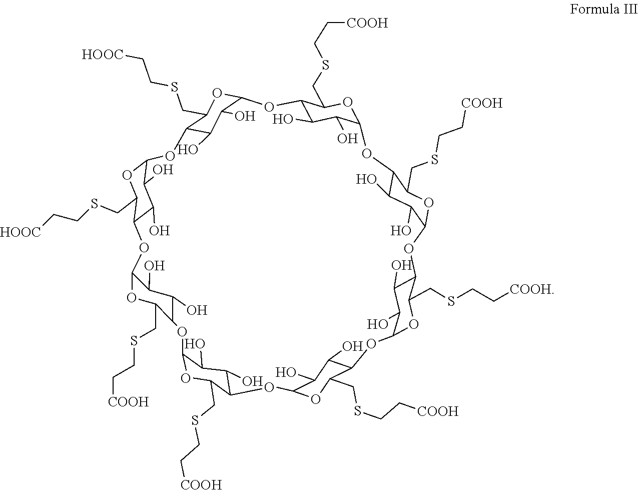 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

In another aspect, the invention provides for a further step comprising, treating the compound of Formula III with a sodium exchange agent in presence of water to form a compound of Formula IV.

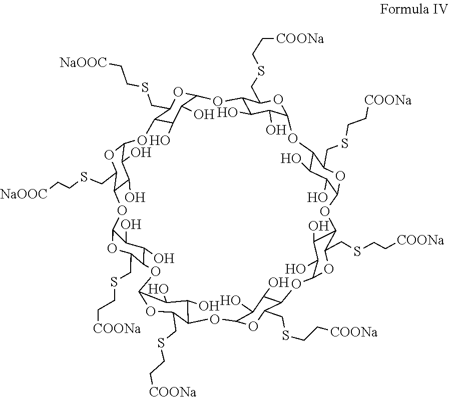

In some such embodiments, the halo is chloro (Formula II-a), bromo (Formula II-b), or iodo (Formula II-c).

Examples of step (b) and step (c) of the process of the invention wherein the halo is Cl are depicted in Scheme 6 and Scheme 7, respectively.

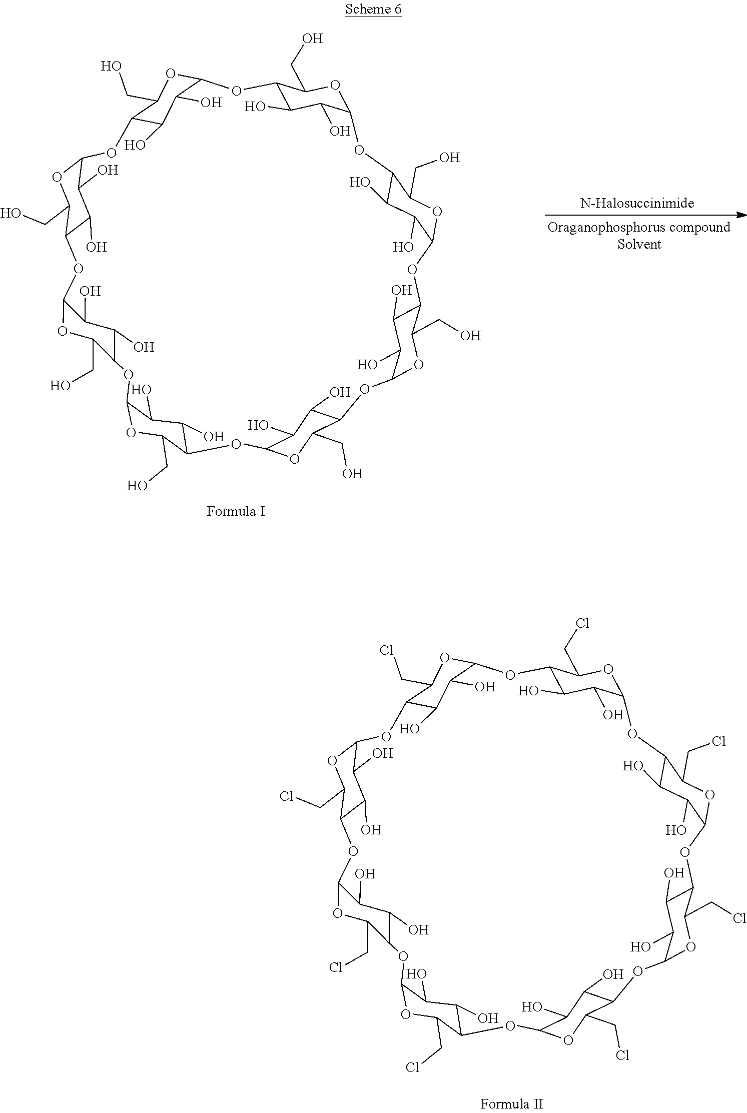 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O ; OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O]

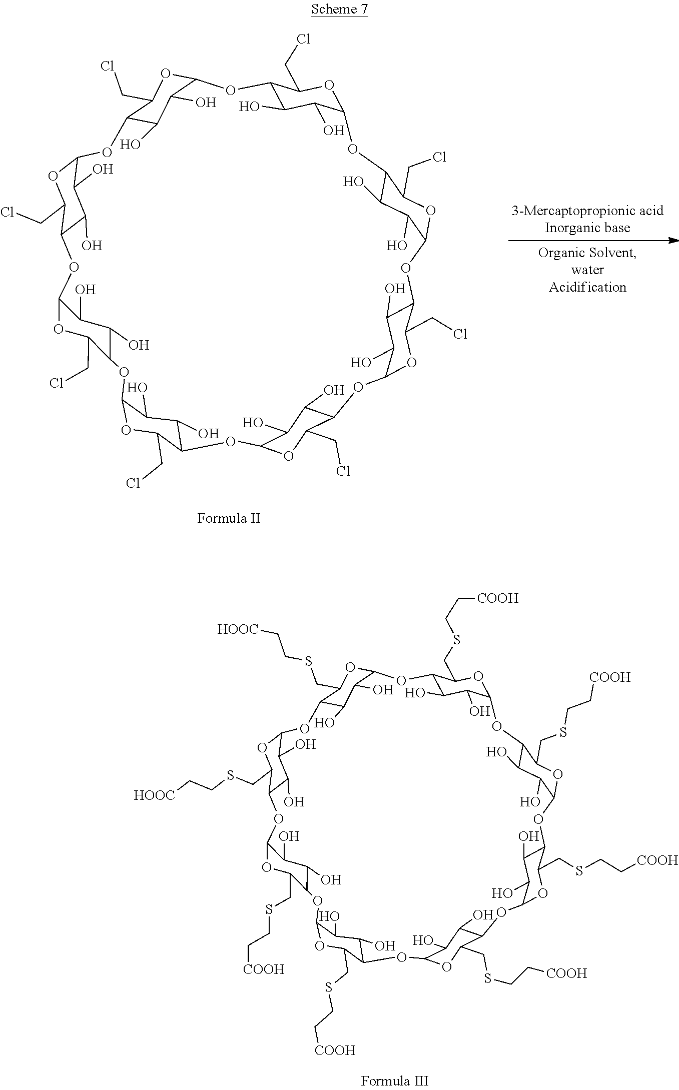 [SMILES: OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O ; O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

In one embodiment of the invention, the compound of Formula II or the compound of Formula III is purified by dissolving in DMF. In some such embodiment, the compound of Formula II or the compound of Formula III is further isolated. In a particular embodiment, the compound of Formula II is Formula II-a. In some embodiments of each of the foregoing, an anti-solvent is added to re-precipitate the compound of Formula II-a, and Formula III. Examples of anti-solvent include but are not limited to, alcohols (e.g., methanol, ethanol, isopropyl alcohol (IPA), butanol), ketonic family (e.g., acetone, methyl ethyl ketone, methylisobutyl ketone) and solvents like acetonitrile, water, ethyl acetate, methylene dichloride (MDC), or mixtures thereof. In a preferred embodiment, the anti-solvent for Formula II-a is a mixture of water:tert-Butanol. In some such embodiment, the anti-solvent is at a ratio of 1:1 volume water per volume tert-Butanol. In another preferred embodiment, the anti-solvent for Formula III is water.

In one embodiment of the invention, the anti-solvent used for isolating the compound of Formula II is a mixture of tert-butanol and water at a ratio of 1:1 (v/v). In specific embodiments, the anti-solvent used for isolating the compound of Formula III is water.

In one embodiment of the invention, the compound of Formula IV is purified using water. In a specific embodiment, the compound of Formula IV is further isolated using an anti-solvent, wherein the anti-solvent is dimethylformamide (DMF).

The compound of Formula II (6-perdeoxy-6-per-halo gamma cyclodextrin) can be prepared by halogenation of gamma cyclodextrin with a suitable halogenating reagent in a suitable organic solvent. In one embodiment, 1 mole of gamma cyclodextrin is used.

In one embodiment of the invention, the organic solvent of step (a) is a polar organic solvent. In some such embodiments, the polar organic solvent of step (a) is selected from the group consisting of dimethylformamide (DMF), dimethylsulphoxide (DMSO), dimethylacetamide (DMAc), and mixtures thereof. In a preferred embodiment, the organic solvent of step (a) is DMF.

The suitable halogenating agent in step (b) of the process of the invention can be selected from N-halosuccinimide, oxalyl chloride, oxalyl bromide, thionyl chloride, thionyl bromide, phosphoryl chloride, phosphoryl bromide and hexachloroacetone. In a particular embodiment, the halogenating agent of step (b) is an N-halosuccinimide. In some such embodiments, the N-halosuccinimide is selected form the group consisting of iodosuccinimide, N-bromosuccinimide, N-chlorosuccinimide and mixtures thereof. In a specific embodiment, the N-halosuccinimide is N-chlorosuccinimide.

In some embodiments of each of the foregoing, 10 to 20 mole equivalence of N-chlorosuccinimide is used. In a particular embodiment, 12 mole equivalence of N-chlorosuccinimide is used.

In one embodiment of the invention, an organophosphorus is used in step (b) of the process. In a particular embodiment, the organophosphorus compound is triphenylphosphine. In some such embodiments, 10 to 20 mole equivalence of triphenylphosphine is used for 1 mole equivalence of the compound of Formula I. In a specific embodiment, 12 mole equivalence of triphenylphosphine is used for 1 mole equivalence of the compound of Formula I.

In some embodiments of each of the foregoing, the reaction of step (b) can be carried out at any suitable temperature, but preferably from 40 to 80° C. In a specific embodiment, the reaction of step (b) is carried out at temperature from 50 to 55° C.

In some embodiments of each of the foregoing, a dried compound of Formula I (dried gamma cyclodextrin) is used in step (a). In some embodiments, gamma cyclodextrin is dried using an oven, a Dean-Stark apparatus, vacuum oven drying, de-moisturizing by toluene, cyclohexane, methylene dichloride (MDC), azeotropic distillation using toluene or combinations thereof. In a particular embodiment, the solution of the compound of Formula I (gamma cyclodextrin) is dried by azeotropic distillation using toluene.

In some embodiments, the moisture content of the solution of the compound of Formula I is less than 4.0%. In a particular embodiment, the moisture content of the solution of the compound of Formula I is less than 1.0%.

In some embodiments of each of the foregoing, the pH of the solution of step (b) is adjusted to a range of from 8 to 10. In a specific embodiment, the pH of the solution of step (b) is adjusted to a range of from 9 to 10. In a particular embodiment of each of the foregoing, the pH of the solution of step (b) is adjusted using sodium methoxide in methanol solution, sodium hydroxide solution, potassium hydroxide solution or mixtures thereof. In further embodiments of each of the foregoing, the pH of the solution of step (b) is adjusted using sodium methoxide in methanol solution.

In one embodiment of the invention, 20 to 30 mole equivalence of 3-mercaptopropionic acid with respect to a compound of Formula II is used in step (c). In a specific embodiment, 25 mole equivalence of 3-mercaptopropionic acid with respect to a compound of Formula II is used.

In one embodiment of the invention, the isolated sugamamdex free acid of Formula III is washed with organic solvents. In another embodiment, the organic solvent of step (c) is a polar organic solvent. In some such embodiments, the polar organic solvent of step (c) is selected from the group consisting of dimethylformamide (DMF), dimethylsulphoxide (DMSO), dimethylacetamide (DMAc), C₁-C₄ alcohols (like methanol, Ethanol, Isopropyl alcohol, Butanols), ketone (like acetone, acetonitrile), and mixtures thereof. In a particular embodiment, the polar organic solvent of step (c) is acetonitrile.

In some embodiments of each of the foregoing, the inorganic base of step (c) is potassium hydroxide, sodium hydroxide, sodium methoxide, sodium hydride, triethyl amine, cesium carbonate, or mixtures thereof. In a preferred embodiment, the inorganic base of step (c) is potassium hydroxide.

In one embodiment of the invention, the water is added in step (c) at a 0.5:1, 1:1 or 1.5:1 ratio volume water per volume of compound of Formula II. In one such embodiment, a 1.5:1 ratio volume water per volume of compound of Formula II is added.

In a specific embodiment, the water is a demineralized water. In some such embodiments, the time interval for addition of demineralized water to step (c) is after 1 to 3 hours of heating the reaction mixture to 50 to 55° C.

In one embodiment of the invention, the process of step (c) is carried out at temperature from 40 to 80° C. In a preferred embodiment, the process of step (c) is carried out at temperature from 50 to 55° C.

In one embodiment of the invention, the reaction mixture is acidified to isolate the sugammadex acid using dilute hydrochloric acid.

The completion of the reaction can be monitored by any suitable analytical technique. After completion of the reaction sugammadex acid (Formula III) may be isolated by any known methods which may include but are not limited to cooling crystallization, anti-solvent addition, removal of solvent by evaporation, distillation, filtration of precipitated solid and the like; or any combinations of these methods.

The purified sugammadex acid (Formula III) may be optionally washed with suitable solvent and dried under suitable drying conditions. The drying may be suitably carried out using any of an air tray dryer, vacuum tray dryer, fluidized bed dryer, spin flash dryer, flash dryer, and the like. The drying may be carried out at any suitable temperatures and under atmospheric pressure or above, or under reduced pressures.

In certain embodiments, the invention provides a process for converting sugammadex acid into sugammadex sodium. (Scheme 8)

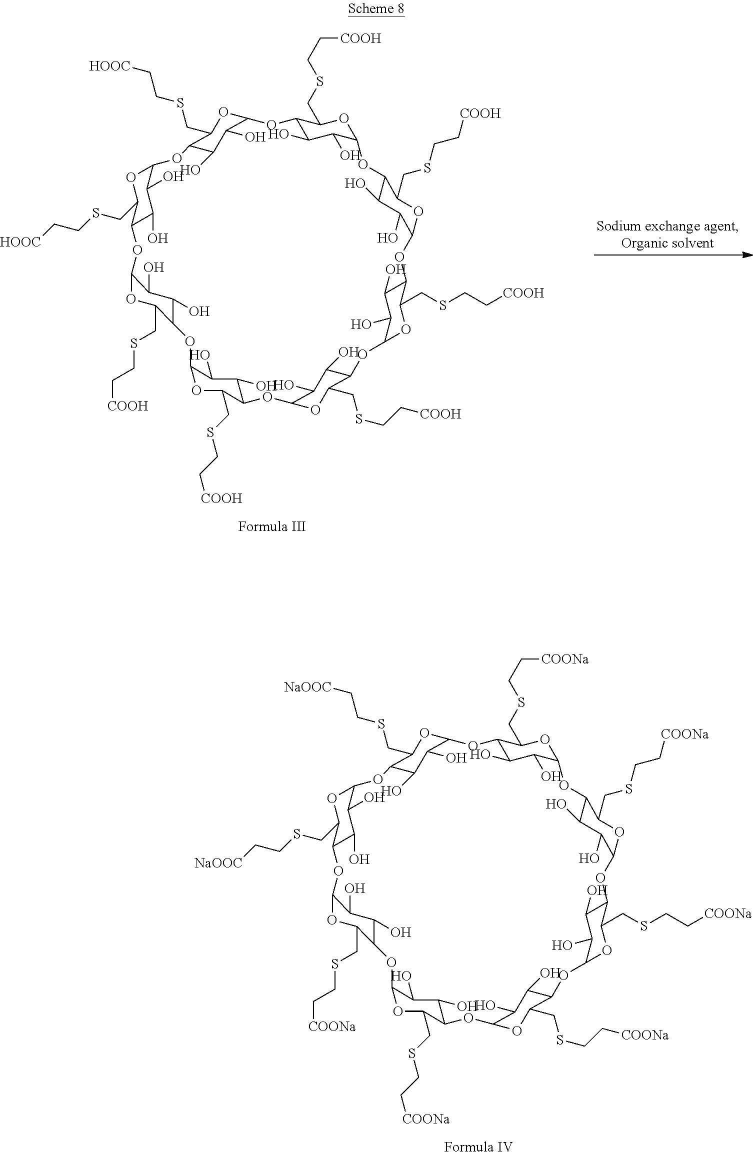

In one embodiment, the sodium exchange agent is sodium hydroxide, sodium-2-ethyl hexanoate or mixtures thereof. In a preferred embodiment, the sodium exchange agent is sodium-2-ethyl hexanoate. In some such embodiments, 10 mole equivalence of sodium-2-ethyl hexanoate is used.

In another aspect of the invention, the crude sugammadex sodium obtained is purified to obtain a purified product of the sugammadex sodium. In some such embodiments, the purification of sugammadex sodium of Formula IV, comprises the steps of: (i) dissolving the crude sugammadex sodium in water; (ii) adding water miscible solvent; (iii) optionally adding activated carbon to the solution obtained in step (i) and maintaining for a sufficient time; (iv) optionally filtering the contents of the mixture obtained in step (iii); (v) optionally heating the filtrate obtained in step (iv); (vi) optionally adding the water miscible solvent to the contents obtained in steps (i), (iv) and (v); (vii) optionally cooling the contents obtained in step (vi) for sufficient time to obtain a solid; and (viii) optionally repeating any one or combination of steps (i) to (vii).

In one embodiment, the water miscible solvent is selected from the group consisting of acetone, acetonitrile (ACN), tetrahydrofuran (THF), dimethylacetamide (DMAc), dimethylsulphoxide (DMSO), dimethylformamide (DMF), C₁-C₄ alcohols and mixtures thereof. In a particular embodiment, the C₁-C₄ alcohol is methanol, ethanol, isopropyl alcohol or mixtures thereof. In some specific embodiments, the water miscible solvent is DMF. In a particular embodiment, 5 to 30 volumes of DMF is added. In a preferred embodiment, 11 volumes of DMF is added.

In some embodiments, step (e) of the purification of sugammadex sodium of Formula IV, is carried out at temperature from 0 to 100° C. In a preferred embodiment, step (e) is carried out at temperature from 25 to 35° C.

In one embodiment, 1 to 10 volumes of water is added in step (i) of the process of the purification of sugammadex sodium of Formula IV. In a particular embodiment, 4 volume of water is added.

In one aspect of the invention, the process for preparing sugammadex acid of Formula III comprises the steps of: (a) providing a solution comprising a compound of Formula I and an organic solvent; (b) reacting the solution of step (a) with a halogenating agent and triphenylphosphine to obtain a compound of Formula II, wherein X is Cl (the compound of Formula II-a);

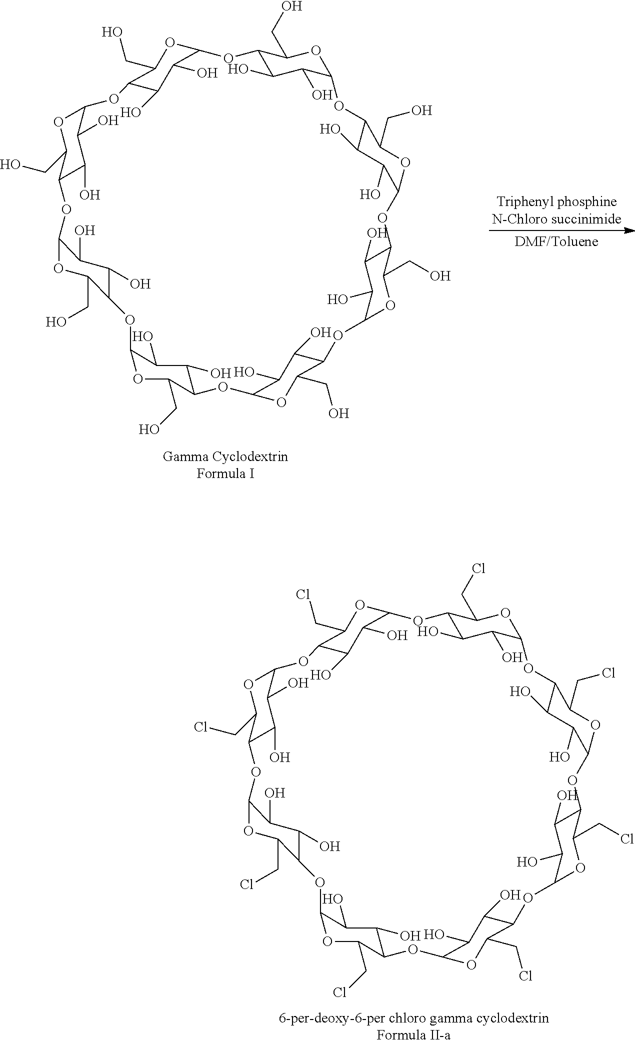 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O ; OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O]

(c) reacting the compound of Formula II-a with 3-mercaptopropionic acid in the presence of an organic solvent, an inorganic base, and water followed by acidification to obtain a compound of Formula III; and

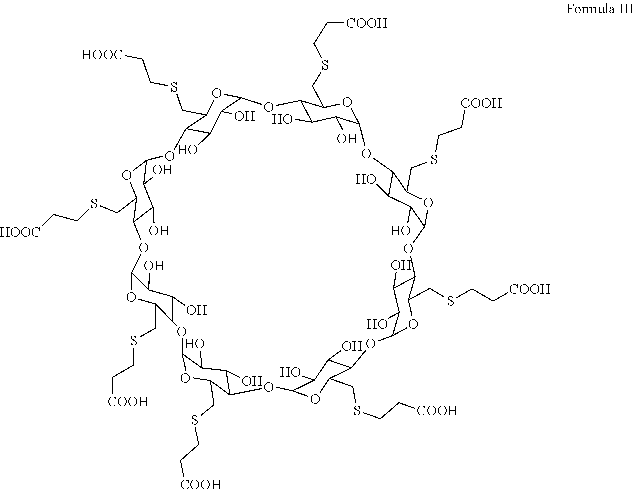 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

(d) treating the compound of Formula III with a sodium exchange agent in presence of water to form a compound of Formula IV;

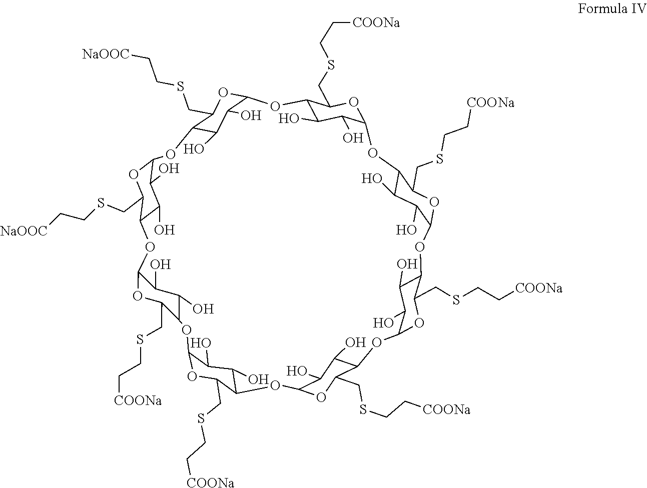

and wherein: (i) the compound of Formula II-a and the compound of Formula III are purified by dissolving in DMF; (ii) the compound of Formula II is further isolated using a mixture of tert-butanol and water at a ratio of 1:1 (v/v); (iii) the anti-solvent used for isolating compound of Formula III is water; (iv) the compound of Formula IV is purified using water; (v) the compound of Formula IV is further isolated using an anti-solvent of DMF; (vi) the halogenating agent of step (b) is an N-chlorosuccinimide; (vii) twelve mole equivalence of N-chlorosuccinimide and 12 mole equivalence of triphenylphosphine are used for 1 mole equivalence of the compound of Formula I; (viii). the reaction of step (b) is carried out at temperature from 50 to 55° C.; (ix) the reaction of step (b) is carried out in 5 to 7 hours; (x) the solution of the compound of Formula I is dried by azeotropic distillation using toluene; (xi) the moisture content of the solution of the compound of Formula I is less than 1.0%; (xii) the pH of the solution of step (b) is adjusted to a pH of a range from 9 to 10 using sodium methoxide in methanol solution; (xiii) 25 mole equivalence of 3-mercaptopropionic acid with respect to Formula II is used; (xiv) the organic solvent of step (c) is acetonitrile; (xv) the inorganic base of step (c) is potassium hydroxide; (xvi) a 1.5:1 ratio volume water per volume of the compound of Formula II; (xvii) the water in step (c) is added after 1 to 3 hours of heating the reaction mixture to 50 to 55° C.; (xviii) the process of step (c) is carried out at temperature from 50 to 55° C.; and (xix) the sodium exchange agent is sodium-2-ethyl hexanoate.

The invention is further illustrated with following non-limiting examples:

### EXAMPLES

### Example 1: Process for Preparation of Sugammadex Acid

The process for synthesis of step I intermediate (chloro gamma cyclodextrin) using thionyl chloride as chlorinating agent is outlined as follows. (Scheme 9)

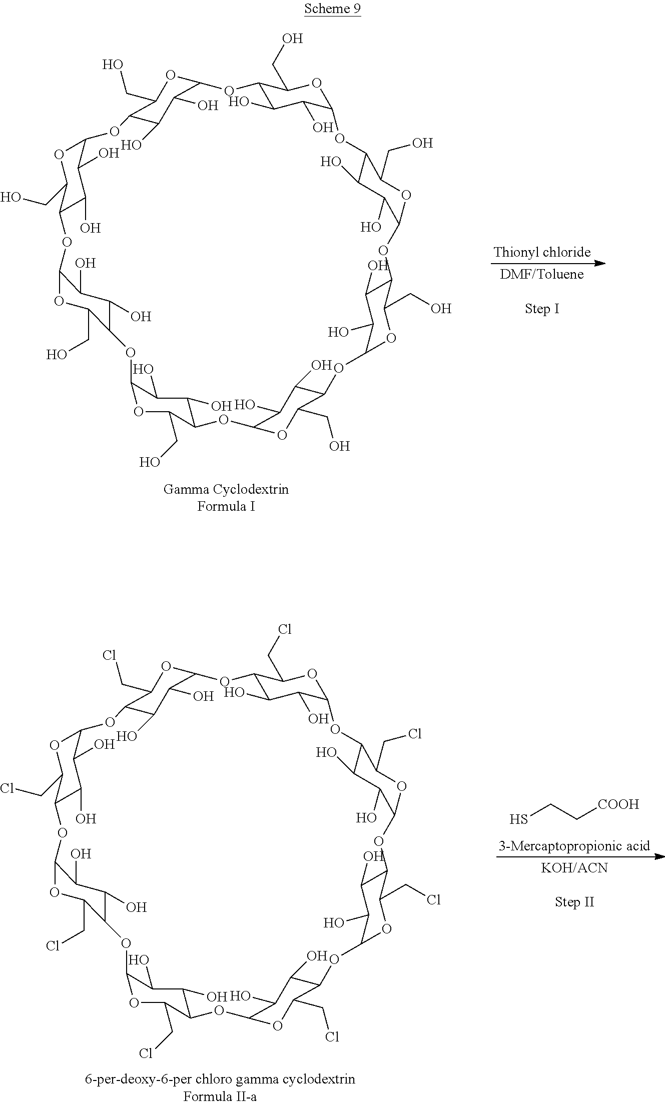 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O ; OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O ; O=C(O)CCS]

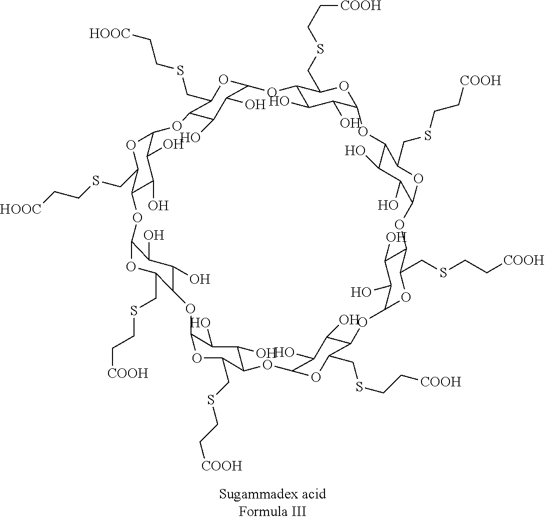 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

### Step I:

Gamma cyclodextrin (25.0 grams, 1 mole equivalence) was mixed with toluene (250 mL, 10 V) and was refluxed using Dean-Stark apparatus. After the removal of water from cyclodextrin, toluene was completely removed by atmospheric distillation and DMF (425 mL, 17 V) was added to the mixture. Thionyl chloride (35 mL, 25 mole equivalence) was added drop by drop at 0 to 5° C. to the reaction mixture. The reaction was maintained at 65 to 70° C. for 14 to 16 hours. After the reaction, diisopropyl ether (300 mL) was added and the layers were separated. The viscous layer was basified to pH 8 to 9 using 10% sodium hydroxide solution at 0 to 5° C. The solid was filtered and washed with DM water. The wet solid was slurried with methanol and dried under vacuum to obtain chloro gamma cyclodextrin (25.5 grams). The obtained chloro gamma cyclodextrin (Formula II-a) had a yield of 91.6%.

### Step II:

Potassium hydroxide (9.7 grams, 50 mole equivalence) was added to acetonitrile (75.0 mL) and the mixture was cooled to 0 to 5° C. To this slurry, a solution of 3-mercaptopropionic acid (7.7 mL, 25 mole equivalence) in 25 mL acetonitrile was added slowly at 0 to 5° C. under nitrogen atmosphere. The reaction mixture was maintained at 0 to 5° C. for 1 hour. Next, 6-perdeoxy-6-chloro gamma cyclodextrin (5.0 grams, 1 mole equivalence) was added to the slurry and the reaction mixture was heated to 50 to 55° C. and maintained at 50 to 55° C. under nitrogen atmosphere. After 3 hours, water (7.5 mL, 1.5 V) was added to the reaction mixture and the reaction continued for an additional 7 hours. The acetonitrile layer was decanted off from the reaction mixture. Water (100 mL) was added to the bottom layer and the mixture was filtered to remove any undissolved solid. The pH of the filtrate was adjusted to pH of 2 to 2.5 using 10% Aqueous HCl solution at 10 to 15° C. The reaction mixture was stirred and the solid was filtered under nitrogen atmosphere. The reaction mixture was slurried with ethyl acetate (30 mL). The solid was then dried under vacuum at 25 to 35° C. to obtain sugammadex acid (4.5 grams). The obtained sugammadex acid (Formula III) had a yield of 65.2%.

### Example 2: Process for Preparation of Sugammadex Sodium

### Step I:

The process for synthesis of step I intermediate (chloro gamma cyclodextrin) using triphenylphosphine oxide and oxalyl chloride is outlined as follows. (Scheme 10)

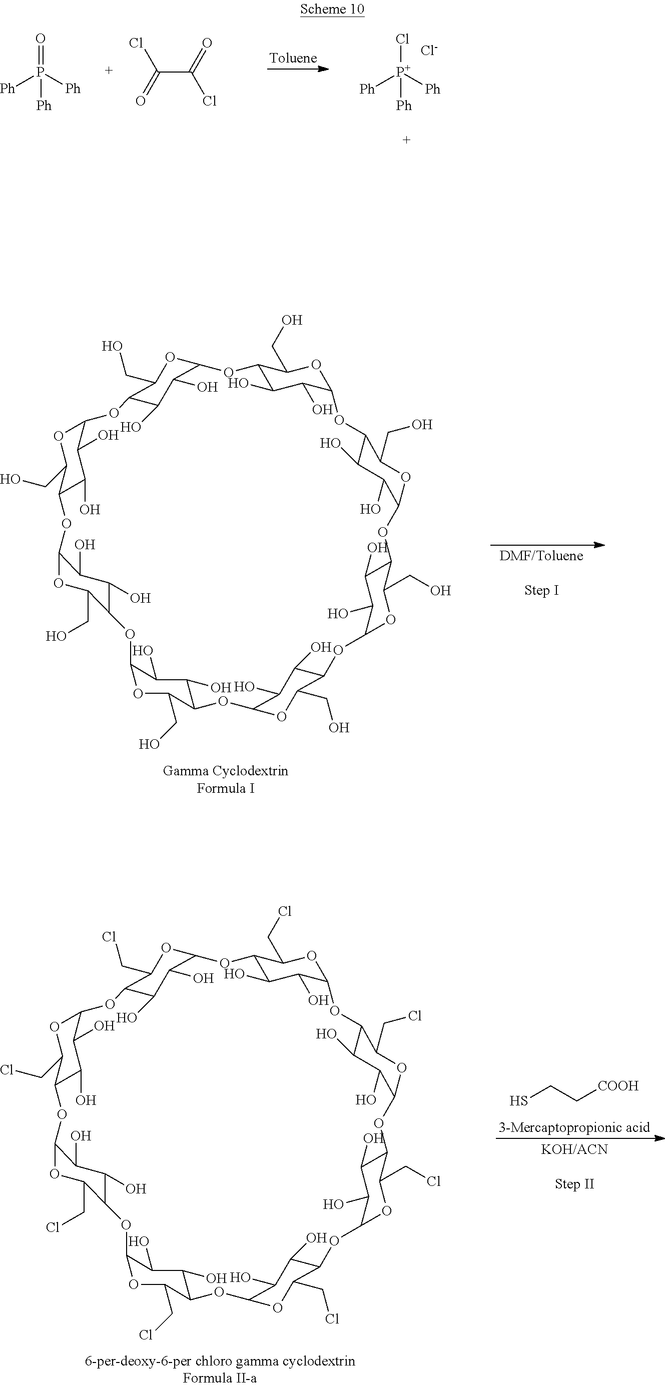

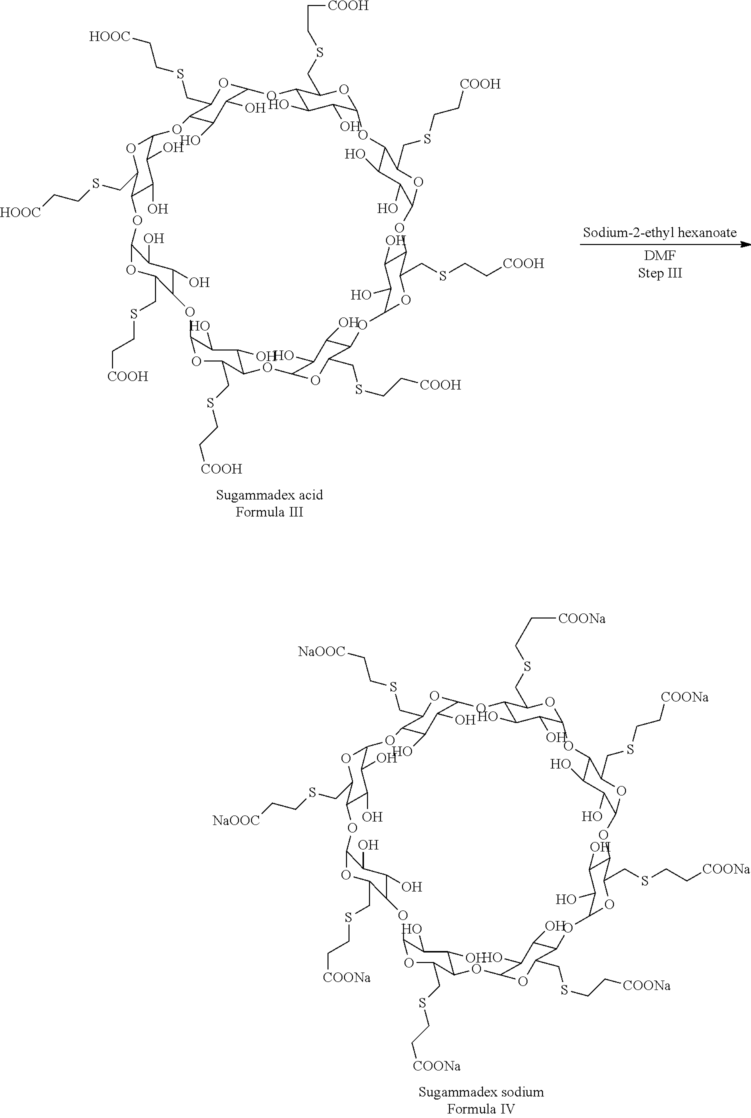

Gamma cyclodextrin (10.0 grams, 1 mole equivalence) was mixed with toluene (10 V, 100 mL) and was refluxed using Dean-Stark apparatus. After removal of water from cyclodextrin, toluene was completely removed under vacuum and DMF (70 mL, 7 V) was added. Meanwhile in another setup, DMF (120 mL, 12 V), triphenylphosphine oxide (1.0 grams, 10% w/w to batch size) was taken and cooled to 0 to 5° C. Oxalyl chloride (50 mL, mole equivalence) was added drop by drop at 0 to 5° C. The reaction mixture was stirred at 25 to 35° C. for 1 hour. The cyclodextrin in DMF solution was added to this mixture at 5 to 10° C. for 30 minutes. The reaction mixture was maintained at 65 to 70° C. for reaction completion. The reaction mixture was added to DM water, diisopropyl ether was added and the layers were separated. The aqueous layer was basified to pH 8 to 9 using 10% sodium hydroxide solution at 0 to 5° C. The solid was filtered and washed with water. The wet solid was slurried with methanol and washed with isopropyl ether (IPE) and dried under vacuum to obtain chloro gamma cyclodextrin (Formula II-a) (10.2 grams). The obtained chloro gamma cyclodextrin Formula II-a) had a yield of 92.0%.

### Step II:

Potassium hydroxide (9.7 grams, 50 mole equivalence) was added to acetonitrile (75 mL, 15 V) and cooled to 0 to 5° C. A solution of 3-mercaptopropionic acid (7.7 mL, mole equivalence) in (5 V, 25 mL) acetonitrile was added slowly to this slurry at 0 to 5° C. under nitrogen atmosphere. The reaction mixture was maintained at 0 to 5° C. for 1 hour. 6-perdeoxy-6-chloro gamma cyclodextrin (5.0 grams, 1 mole equivalence) was added to the slurry. The reaction mixture was heated to 50 to 55° C. and maintained at 50 to 55° C. under nitrogen atmosphere. After 3 hours, water (7.5 mL, 1.5 V) was added to the reaction mixture and the reaction continued for an additional 7 hours. The acetonitrile layer was decanted off from the reaction mixture. Water (100 mL, 20 V) was added to the bottom layer and the reaction mixture was filtered to remove any undissolved solid. The pH of the filtrate was adjusted to pH of 2 to 2.5 using 10% aqueous HCl solution at a temperature of 10 to 15° C. The reaction mixture was stirred; the solid was filtered under nitrogen atmosphere and slurried with ethyl acetate (30 mL). The solid was dried under vacuum at 25 to 35° C. to obtain sugammadex acid (4.6 grams). The obtained sugammadex acid (Formula III) had a yield of 66.3% with a purity of 93.75% as measured by HPLC.

### Step III:

Sugammadex acid (4.5 grams, 1 mole equivalence) as prepared in Step II was dissolved in (67.5 mL, 15 V) DMF under nitrogen atmosphere. To this solution, sodium-2-ethyl hexanoate (4.5 grams, 12 mole equivalence) in DMF (22.5 mL, 5 V) was added slowly at 25 to 35° C. The slurry was stirred, filtered to remove the solid under nitrogen atmosphere and washed with acetone. The crude product was purified using water (22.5 mL, 5 V):acetone (135 mL, 30 V) and the solid dried under vacuum at 45 to 50° C. to obtain sugammadex sodium (Formula IV) with a purity of 95.19% as measured by HPLC.

### Example 3: Process for Preparation of Sugammadex Acid

The process for synthesis of step I intermediate (chloro gamma cyclodextrin) using hexachloro acetone is outlined as follows. (Scheme 11)

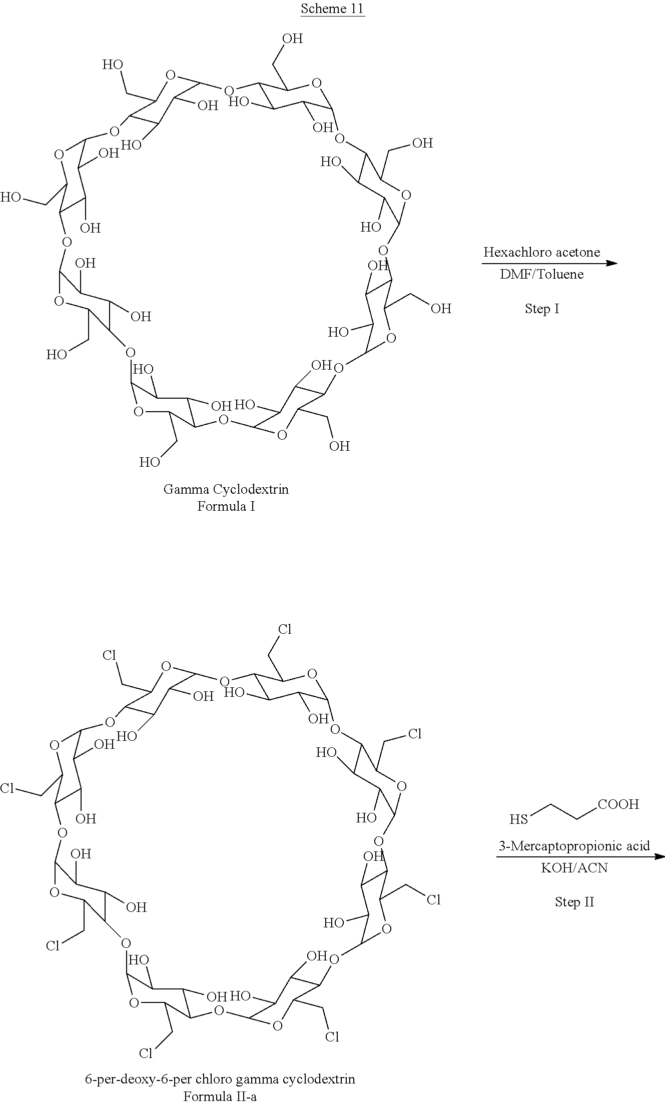 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O ; OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O ; O=C(O)CCS]

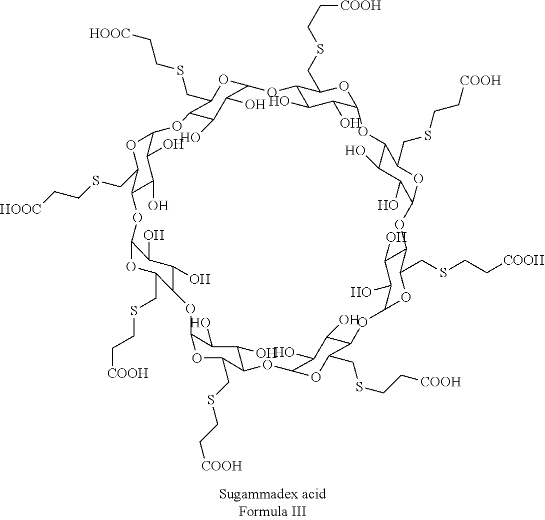 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

### Step I:

Gamma cyclodextrin (5.0 grams, 1 mole equivalence) was dried in vacuum oven, mixed with DMF (50 mL, 10 V) and triphenylphosphine (16.2 grams, 16 mole equivalence) was added to the reaction mixture. The reaction mixture was cooled to 10 to 15° C. Hexachloro acetone (16.3 grams, 16 mole equivalence) was mixed with (25 mL, 5 V) DMF and added to the reaction at 10 to 15° C. The temperature of the reaction mixture was raised to 50 to 55° C. and maintained for 10 hours. After the reaction, (50 mL, 10 V methanol) was added and the reaction mixture was stirred for 30 minutes. The pH of reaction mixture was adjusted to 8.0 to 9.0 using 30% sodium methoxide solution. The reaction mixture was quenched in 600 mL DM water at 10 to 15° C. Methanol (100 mL, 20 V) was added to the reaction mixture and the solid was filtered. The crude solid was slurried with methanol and dried to obtain chloro gamma cyclodextrin (3.5 grams). The obtained chloro gamma cyclodextrin (Formula II-a) had a yield of 62.5%.

### Step II:

To acetonitrile (45.0 ml, 15 V), potassium hydroxide (5.6 grams, 50 mole equivalence) was added and the reaction mixture was cooled to 0 to 5° C. To this slurry, a solution of 3-mercaptopropionic acid (5.4 grams, 25 mole equivalence) in (15 mL, 5 V) acetonitrile was added slowly at 0 to 5° C. under nitrogen atmosphere. The reaction mixture was maintained at 0 to 5° C. for 1 hour. 6-perdeoxy-6-chloro gamma cyclodextrin (3.0 grams, 1 mole equivalence) was added to the slurry and the reaction mixture was heated to 50 to 55° C. The reaction mixture was maintained at 50 to 55° C. under nitrogen atmosphere. After 3 hours, water (4.5 mL, 1.5 V) was added to the reaction mixture and the reaction continued for an additional 7 hours. The acetonitrile layer was decanted off from the reaction mixture; water was added to the bottom layer and filtered to remove any undissolved solid. The pH of the filtrate was adjusted to a pH of 2 to 2.5 using 10% aqueous HCl solution at 10 to 15° C. The reaction mixture was stirred, the solid was filtered under nitrogen atmosphere, and slurried with ethyl acetate. The solid was dried under vacuum at 25 to 35° C. to obtain sugammadex acid (2.4 grams) in a yield of 57.7%.

### Example 4: Process for Preparation of Sugammadex Sodium

The process for synthesis of step I intermediate (chloro gamma cyclodextrin) using oxalyl chloride is outlined as follows: (Scheme 12)

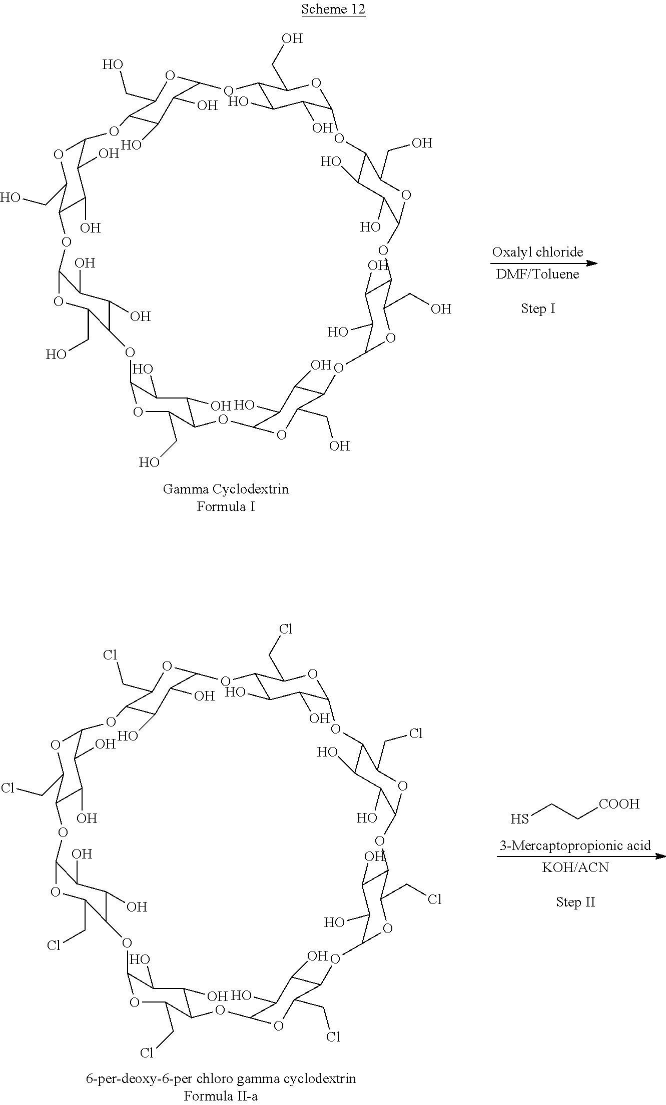 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O ; OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O ; O=C(O)CCS]

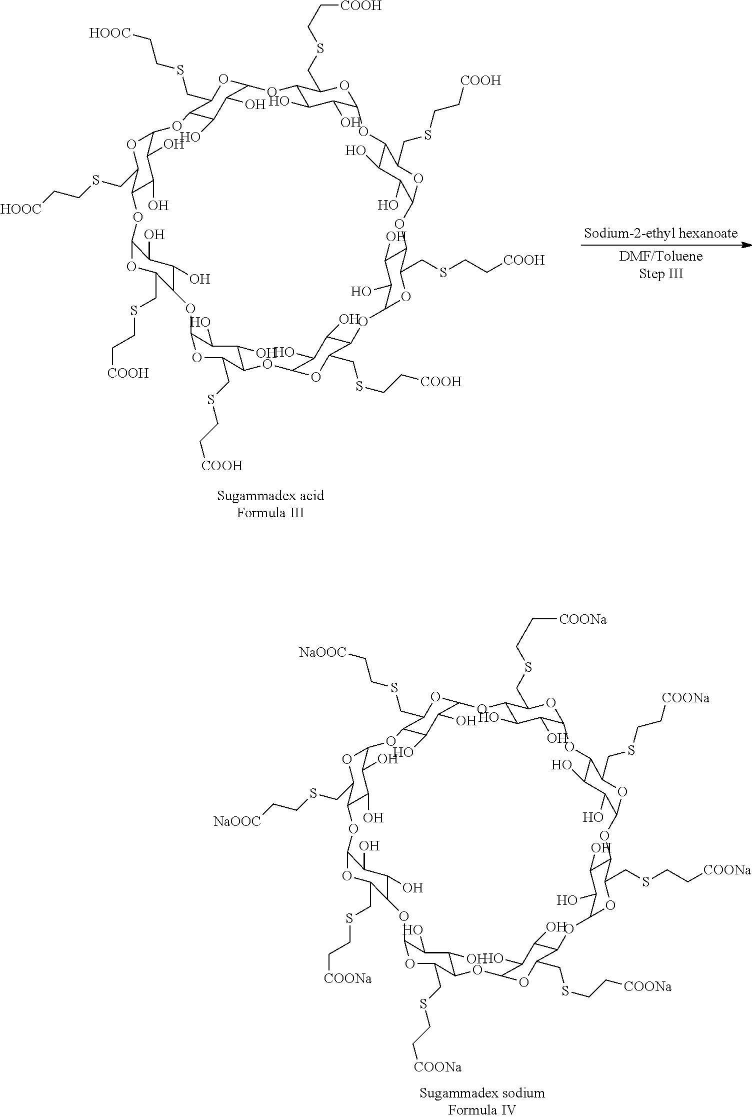

### Step I:

Gamma cyclodextrin (25.0 grams, 1 mole equivalence) was mixed with toluene (250 mL, 10 V) and was refluxed using Dean-Stark apparatus. After removal of water from cyclodextrin, toluene was completely removed by atmospheric distillation. DMF (150 mL, 6 V) was added to the reaction mixture.

In a separate reaction setup, DMF (300 mL, 12 V) was cooled to 0 to 5° C. and oxalyl chloride (50 mL, 30 mole equivalence) was added drop by drop for around 2 hours at a temperature of 0 to 5° C. The reaction mixture was stirred at 25 to 35° C. for 1 hour. The cyclodextrin in DMF solution was added to this mixture at 5 to 10° C. for 30 minutes. The temperature of the reaction mixture was raised to 60 to 70° C. and maintained for 14 to 15 hours. After the reaction, diisopropyl ether (300 mL) was added followed by addition of DM water (100 mL). The layers were separated, and the aqueous layer was basified to pH of 8 to 9 using 10% sodium hydroxide solution at 0 to 5° C. Water (500 mL) was added and the solid was stirred well. The solid was filtered and the solid was washed with diisopropyl ether. The solid was dried under vacuum at 50 to 60° C. to obtain chloro gamma cyclodextrin (Formula II-a) (26.2 grams). The obtained chloro gamma cyclodextrin had a yield of 94%.

### Step II:

To acetonitrile (75 mL), potassium hydroxide (9.7 grams, 50 mole equivalence) was added and cooled to 0 to 5° C. To this slurry, a solution of 3-mercaptopropionic acid (7.7 mL, 25 mole equivalence) in 25 ml acetonitrile was added slowly at 0 to 5° C. under nitrogen atmosphere. The reaction mixture was maintained at 0 to 5° C. for 1 hour. 6-perdeoxy-6-chloro gamma cyclodextrin (5.0 grams) was added to the slurry. The temperature of the reaction mixture was raised to 50 to 55° C. and maintained at 50 to 55° C. under nitrogen atmosphere. After 3 hours, water (7.5 mL, 1.5 V) was added to the reaction mixture and the reaction continued for a further 7 hours. The acetonitrile layer was decanted off from the reaction mixture and 100 mL water was added to the bottom aqueous layer. The reaction mixture was filtered to remove any undissolved solid. The pH of the filtrate was adjusted to a pH of 2 to 2.5 using 38 mL of 10% aqueous HCl solution 10 to 15° C. The reaction mixture was stirred; the solid was filtered under nitrogen atmosphere and was slurried with ethyl acetate (30 mL). The solid was vacuum dried at to 35° C. to obtain sugammadex acid 5.0 grams. The obtained sugammadex acid (Formula III) had a yield of 72% with a purity of 94.5% measured by HPLC.

### Step III:

Sugammadex acid (5.0 grams) as prepared in Step II was dissolved in 4 V DMF under nitrogen atmosphere. To this solution, sodium-2-ethyl hexanoate (3.8 grams, 9 mole equivalence) in (30 mL, 6 V) DMF was added slowly at 25 to 35° C. under nitrogen atmosphere. The slurry was stirred and the solid was filtered under nitrogen atmosphere and washed with acetone. The crude sugammadex sodium was purified using water (25 mL, 5 V): acetone (150 mL, 30 V) and the solid dried under vacuum at 45 to 50° C. (4.0 grams). The sugammadex sodium (Formula IV) had a yield of 73.5% with a purity of 95.36% measured by HPLC.

### Example 5: Alternate Process for Sugammadex Sodium Using Sodium Hydroxide (Scheme 13)

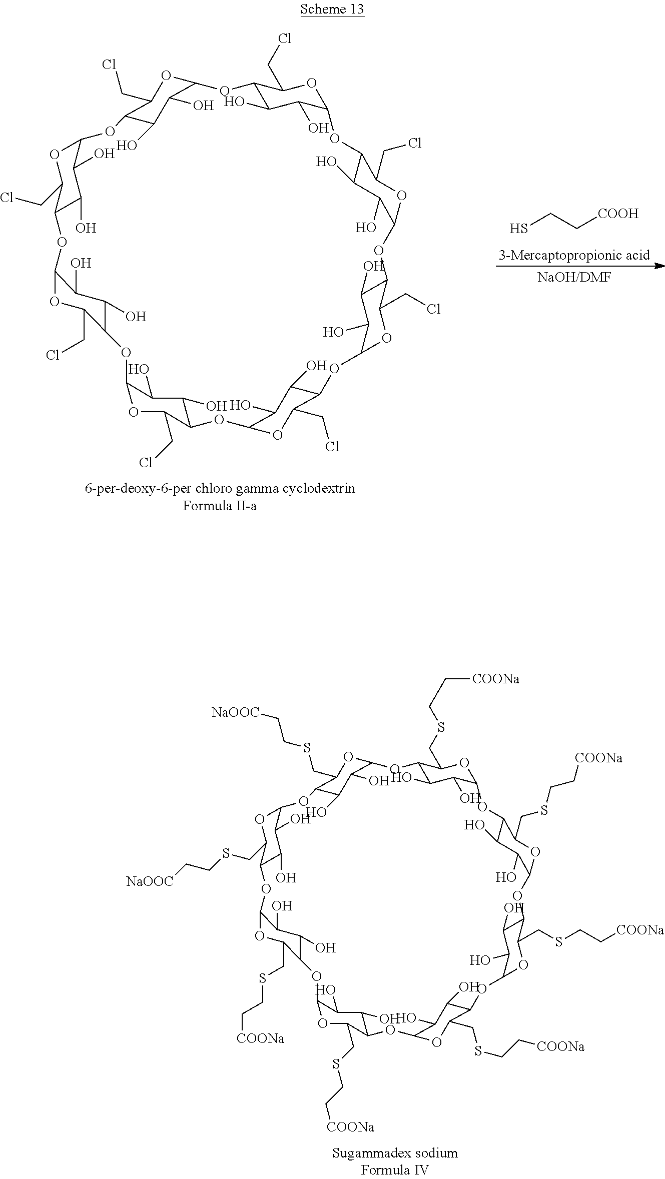

To a solution of sodium hydroxide (12.5 grams, 30 mole equivalence in 15.0 mL DM water), DMF (300.0 ml, 20 V) was added. A solution of 3-mercaptopropionic acid (13.5 mL, 15 mole equivalence) in 150 mL DMF (10 V) was added slowly at 0 to 5° C. under nitrogen atmosphere. The reaction mixture was maintained at 0 to 5° C. for 1 hour. 6-perdeoxy-6-chloro gamma cyclodextrin (15.0 grams, 1 mole equivalence) was dissolved in DMF (150 mL, 10 V) and was added at 5 to 10° C. to the reaction mixture. The reaction mixture was maintained at 75 to 80° C. under nitrogen atmosphere for 16 to 20 hours. After the completion of reaction, methanol (225.0 ml, 15 V) was added to the reaction mixture under stirring and the resulting solid was filtered using Buchner funnel.

The crude solid was dissolved in DM water (150 mL, 10 V) and activated carbon (1 gram) was added. The reaction mixture was maintained at 45 to 50° C. for 30 minutes and filtered through CELITE bed and the bed washed with DM water (75 mL, 5 V). Methanol was added to the filtrate at 55 to 60° C. to result in white solid which was filtered and dried under vacuum at 45 to 50° C. Sugammadex sodium (Formula IV) (12.0 grams) was obtained with a purity of 81.57% measured by HPLC.

### Example 6: Preparation of Chloro Gamma Cyclodextrin (Scheme 14)

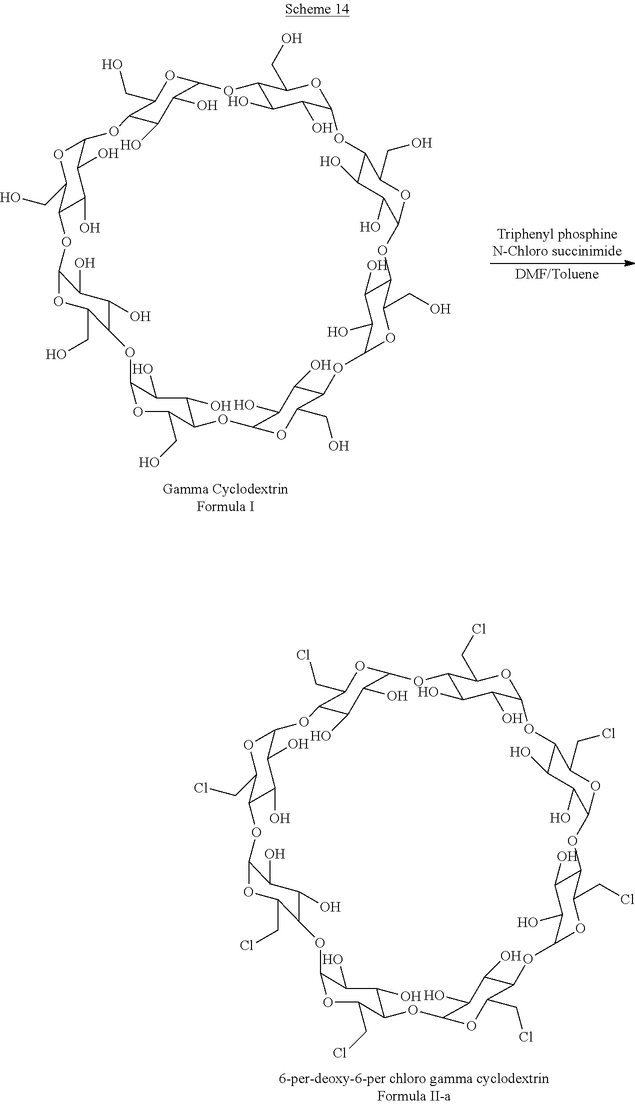 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O ; OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O]

Gamma cyclodextrin (50.0 grams, 1 mole equivalence) was added to 500 mL toluene. This slurry was heated using Dean-Stark apparatus at 110 to 115° C. to remove water from gamma cyclodextrin. After removal of water, toluene was removed using distillation. To this solution, 500 mL of DMF was added. Triphenylphosphine (121.2 grams, 12 mole equivalence) was added to the reaction mixture. N-chlorosuccinimide (61.7 grams, 12 mole equivalence) in DMF (250 mL) was added to the reaction mixture at 10 to 25° C. The reaction mixture was heated to 50 to 55° C. and was maintained at 50 to 55° C. for 5 to 10 hours. After the completion of reaction, the mixture was cooled to room temperature. Methanol (500 mL) was added to the mixture while stirring. The pH of the reaction mixture was raised to a pH of about 9 to 10 with slow addition of 30% sodium methoxide in methanol solution. The reaction mixture was added to DM water (6.0 L) at 10 to 15° C. and maintained at 10 to 15° C. The crude solid was then suspended into methanol, the solid was filtered and washed with methanol at 50 to 55° C. to obtain 6-perdeoxy-6-chloro gamma cyclodextrin (42.6 grams). The yield of obtained 6-perdeoxy-6-chloro gamma cyclodextrin (Formula II-a) was 76.5%.

### Example 7: Preparation of Chloro Gamma Cyclodextrin (Scheme 15)

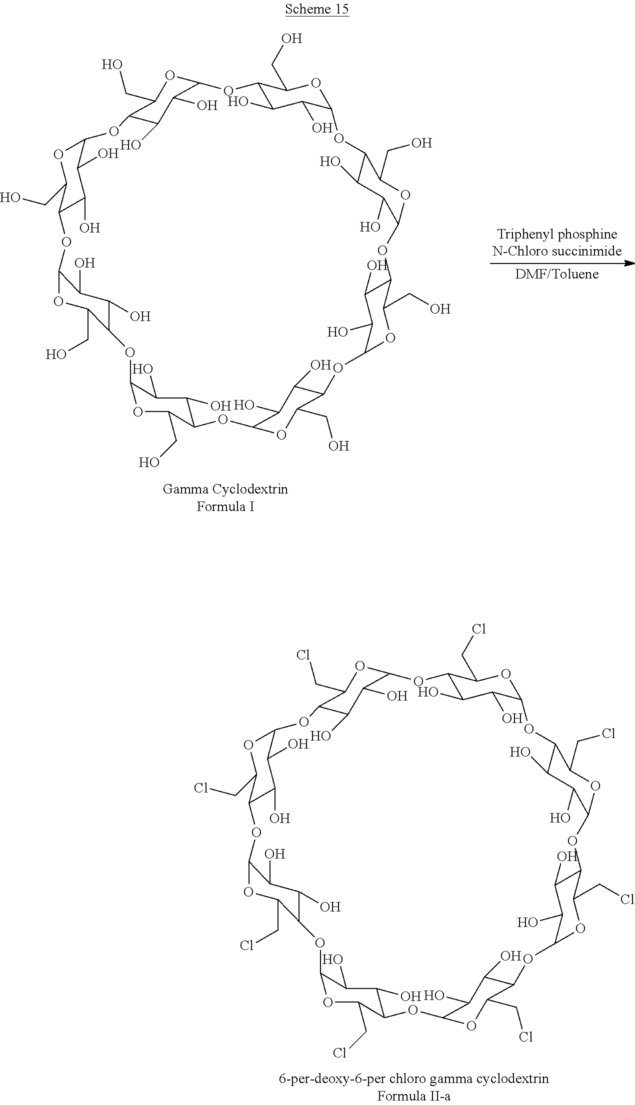 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O ; OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O]

Gamma cyclodextrin (20.0 grams, 1 mole equivalence) was added to 100 mL toluene. This slurry was heated using Dean-Stark apparatus at 110 to 115° C. to remove water from gamma cyclodextrin. After removal of water, toluene was removed using distillation under vacuum. DMF (100 mL) was added. Triphenylphosphine (48.5 grams, 12 mole equivalence) was added to the reaction mixture. N-chlorosuccinimide (24.7 grams, 12 mole equivalence) in DMF (100 ml) was added to the reaction mixture at 25-55° C. The reaction mixture was maintained at 50 to 55° C. for 4 to 10 hours. After the completion of reaction, the reaction mixture was cooled to room temperature. The pH of the reaction mixture was raised to a pH of about 9 to 10 with slow addition of 30% sodium methoxide in methanol (10 mL) solution. The reaction mixture was added to DM water (200 mL, 10 V) and tert-butanol (200 mL, 10 V) mixture (1:1) at 10 to 15° C. and maintained for 2 hours at 10 to 15° C. The reaction mixture was filtered and washed with mixture of water and tert-butanol. The crude wet solid (18.7 grams) was then suspended in methanol (140 mL, 7 V), the solid filtered using Buchner funnel and washed with methanol (20 mL, 1 V) to give 6-perdeoxy-6-chloro gamma cyclodextrin (Formula II-a) (13.2 grams) with a yield of 59.3%.

### Example 8: Purification of Chloro Gamma Cyclodextrin

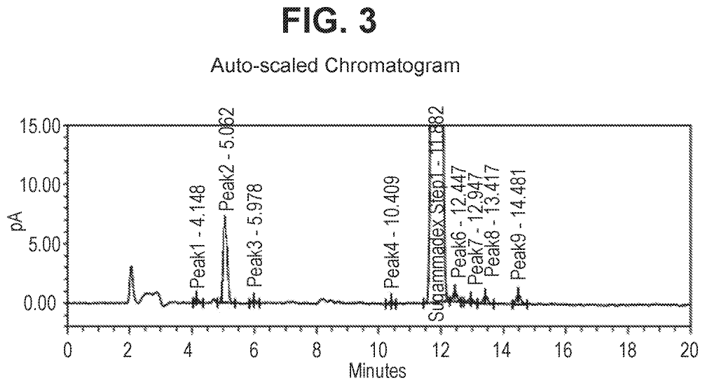

Crude chloro gamma cyclodextrin (10 grams) was dissolved in 50 mL DMF at room temperature. Tert-butanol:water (1:1, 2.5 V) was added to the reaction mixture, cooled and maintained at 0 to 5° C., filtered and washed with tert-butanol:water (1:1.40 mL, 4 V). Pure 6-chloro-6-per deoxy cyclodextrin was obtained (6.9 grams) which had a purity of 97.36% measured by HPLC (Table 1 and FIG. 3).

TABLE 1

| | Name | RT | Area | % Area |
|---|---|---|---|---|
| 1 | Peak1 | 4.15 | 3137313 | 0.09 |
| 2 | Peak2 | 5.06 | 61028043 | 1.68 |
| 3 | Peak3 | 5.98 | 2451085 | 0.07 |
| 4 | Peak4 | 10.41 | 2227108 | 0.06 |
| 5 | Sugammadex Step-1 | 11.88 | 3535547737 | 97.36 |
| 6 | Peak6 | 12.45 | 7731713 | 0.21 |
| 7 | Peak7 | 12.95 | 3830064 | 0.11 |
| 8 | Peak8 | 13.42 | 6885048 | 0.19 |
| 9 | Peak9 | 14.48 | 8482569 | 0.23 |

### Example 9: Purification of Chloro Gamma Cyclodextrin

Ten grams of crude chloro gamma cyclodextrin was dissolved in 50 ml DMF at room temperature. A mixture of 1:1, IPA (20 mL): water (20 mL) was added to the reaction mixture. The reaction mixture was cooled and was maintained at 0 to 5° C. The reaction mixture was filtered and washed with 1:1 IPA:water (40.0 mL, 4 V). The pure 6-chloro-6-per deoxy cyclodextrin (7.0 grams) was obtained which had a purity of 91.79% measured by HPLC.

### Example 10: Preparation of Sugammadex Acid (Scheme 16)

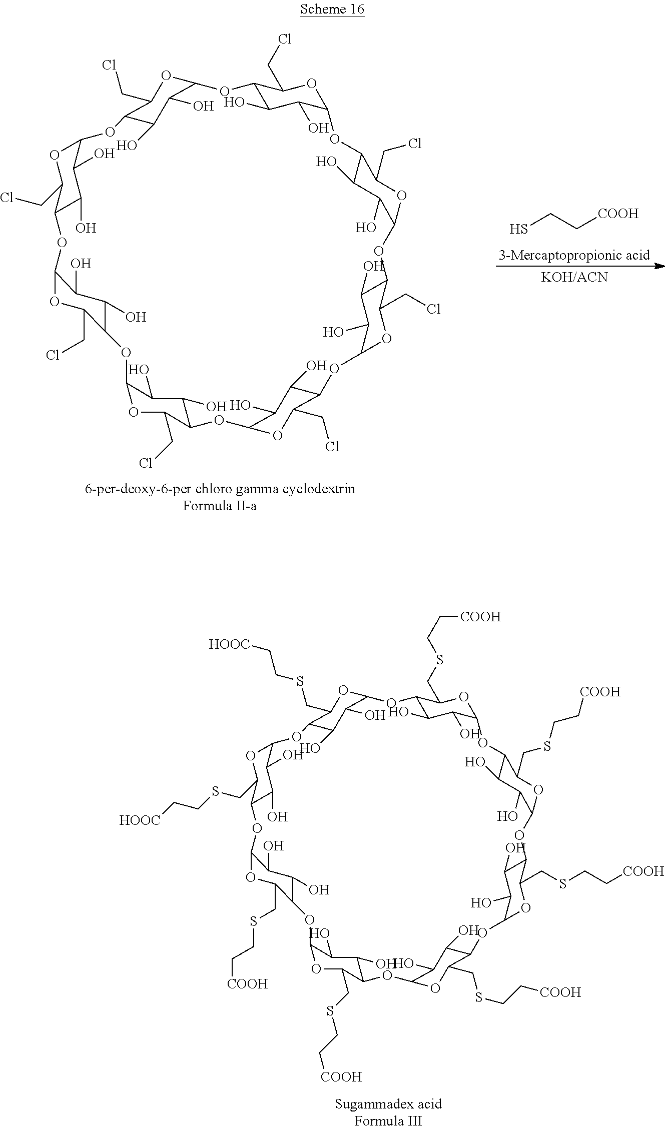 [SMILES: OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O ; O=C(O)CCS ; O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

Potassium hydroxide (59.0 grams, 50 mole equivalence) was added to acetonitrile (450 ml), and cooled to 0 to 5° C. To this slurry, 3-mercaptopropionic acid (56.0 grams, 25 mole equivalence) in acetonitrile solution was added slowly at 0 to 5° C. under nitrogen atmosphere while maintaining the temperature of reaction mixture between 0 to 5° C. for 1 hour. To this slurry, 6-perdeoxy-6-chloro gamma cyclodextrin (30.0 grams, 1 mole equivalence) was added and the reaction mixture was protected from light during the isolation of the compound of Formula II. The temperature of the reaction mixture was raised to 50 to 55° C. and maintained at 50 to 55° C. for 1 to 3 hours. Water (45 mL, 1.5 V) was added to the reaction mixture and maintained reaction mixture at 50 to 55° C. The acetonitrile layer was decanted off from the reaction mixture. Water (600 mL) was added to the bottom aqueous layer and the pH was adjusted to 2 to 2.5 using 10% aqueous HCl at 10 to 15° C. The reaction mixture was stirred for 1 to 2 hours, and the solid was filtered using a sintered funnel under nitrogen atmosphere. The reaction mixture was washed with water (60 mL) to obtain sugammadex acid. The crude solid was slurried in ethyl acetate (300 mL), filtered and dried under vacuum at 25 to 35° C. to obtain 33.2 grams of sugammadex acid (Formula III). Sugammadex acid obtained had purity of 89.16% measured by HPLC.

### Example 11: Purification of Sugammadex Acid

Crude sugammadex acid (33 grams, 1 mole equivalence) was dissolved in (83 mL, 2.5 V) DMF at room temperature. DM water (495 mL, 15 V) was added to the reaction mixture, stirred at 10 to 15° C. and was filtered using a sintered funnel under nitrogen atmosphere. The obtained solid was washed with water (66 mL, 2 V). The solid was further washed with ethyl acetate (165 mL, 5 V) and dried to obtain 19 grams of sugammadex acid (Formula III) which had a purity of 94.4% by HPLC.

### Example 12: Preparation of Sugammadex Sodium

Sugammadex acid (37.5 grams, 1 mole equivalence) was taken in 187.5 mL DM water under nitrogen atmosphere. Nitrogen blanketing is kept during the reaction or purification process to have a control on oxidation impurities. To this suspension, sodium-2-ethyl hexanoate in water (31.2 grams, 10 mole equivalence in 187.5 mL water) was added slowly at 25 to 35° C. under nitrogen atmosphere. To this solution, DMF 825 mL is added and the precipitated solid was filtered under nitrogen atmosphere and washed with DMF (75 mL). Crude sugammadex sodium (32.0 grams) was obtained with a purity of 97.3% measured by HPLC.

### Example 13: Purification of Sugammadex Sodium

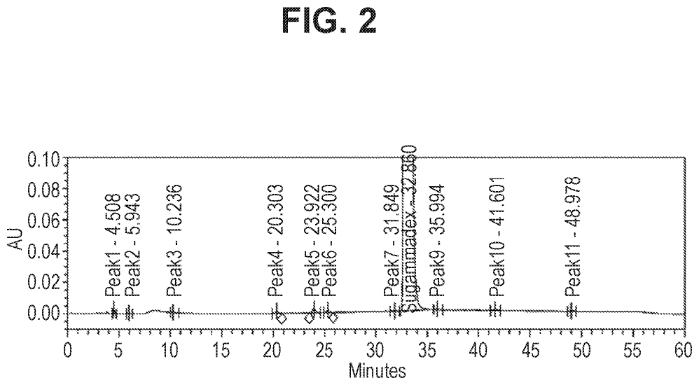

Crude sugammadex sodium (32 grams) was dissolved in (128 mL, 4 V) DM water at room temperature. DMF (352 mL, 11 V) was added slowly to precipitate the solid. The solid was filtered using a sintered funnel, washed with DMF (64 mL, 2 V). The purified solid was dissolved in water (3 V 44 mL). Acetone was added to the reaction mixture. The pure sugammadex sodium had a purity of not less than 99% measured by HPLC. (Table 2 and FIG. 2)

TABLE 2

| | Name | RT | Area | % Area | RT Ratio |
|---|---|---|---|---|---|
| 1 | Peak1 | 4.51 | 28658 | 0.11 | 0.14 |
| 2 | Peak2 | 5.94 | 5172 | 0.02 | 0.18 |
| 3 | Peak3 | 10.24 | 5126 | 0.02 | 0.31 |
| 4 | Peak4 | 20.30 | 33896 | 0.13 | 0.62 |
| 5 | Peak5 | 23.92 | 56469 | 0.21 | 0.73 |
| 6 | Peak6 | 25.30 | 33263 | 0.12 | 0.77 |
| 7 | Peak7 | 31.85 | 5702 | 0.02 | 0.97 |
| 8 | Sugammadex | 32.86 | 26639271 | 99.25 | 1.00 |
| 9 | Peak9 | 35.99 | 13555 | 0.05 | 1.10 |
| 10 | Peak10 | 41.60 | 14248 | 0.05 | 1.27 |
| 11 | Peak11 | 48.98 | 5448 | 0.02 | 1.49 |

While this invention has been disclosed with reference to specific embodiments, it is apparent that other embodiments and variations of this invention can be devised by others skilled in the art without departing from the true spirit and scope of the invention. The subject matter of the invention includes all those other embodiments and variations, including combinations and sub-combinations of the various elements, features, functions, and/or properties disclosed herein. The following claims particularly point out certain combinations and sub-combinations regarded as novel and nonobvious. Inventions embodied in other combinations and sub-combinations of features, functions, elements, and/or properties may be claimed in this application, in applications claiming priority from this application, or in related applications. Such claims, whether directed to a different invention or to the same invention, and whether broader, narrower, equal, or different in scope in comparison to the original claims, also are regarded as included within the subject matter of the inventions of the present disclosure.

1. A process for preparing sugammadex acid of Formula III comprising the steps of:
a. providing a solution comprising a compound of Formula I and an organic solvent; 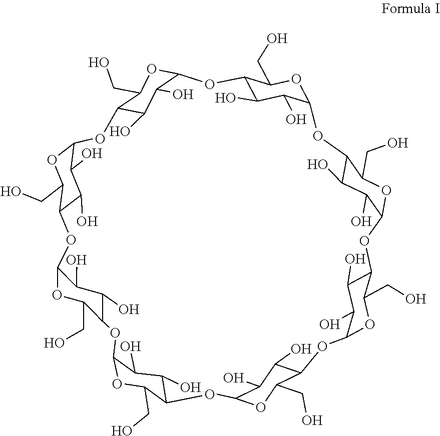 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O]
b. reacting the solution of step (a) with a halogenating agent and triphenylphosphine to obtain a compound of Formula II, 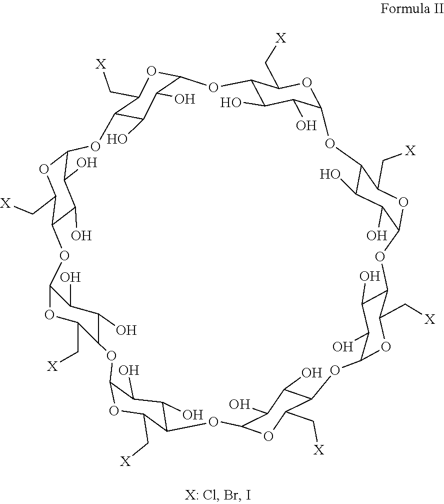
wherein X is a halo; and
c. reacting the compound of Formula II with 3-mercaptopropionic acid in the presence of an organic solvent, an inorganic base, and water followed by acidification to obtain a compound of Formula III

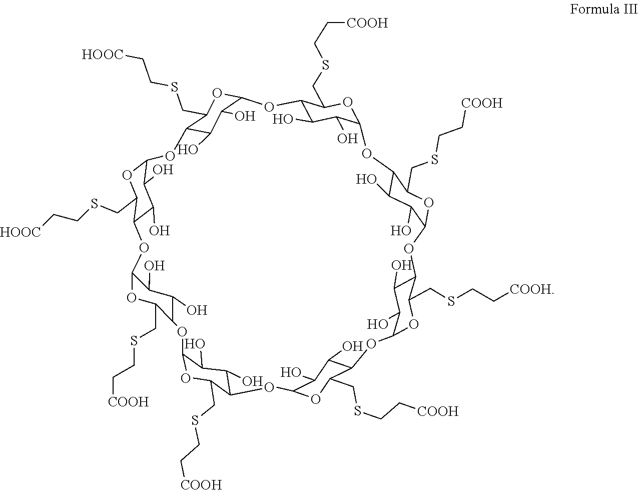 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]

2. The process of claim 1, further comprising treating the compound of Formula III with a sodium exchange agent in presence of water to form a compound of Formula IV

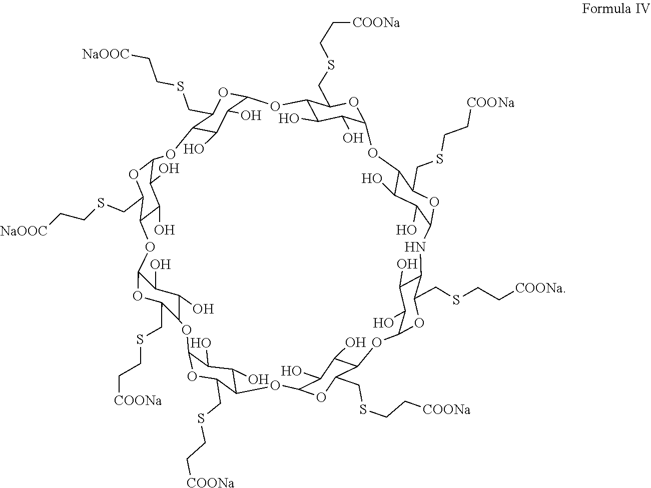

3. (canceled)

4. The process of claim 2, wherein the halo is Cl (the compound of Formula II-a).

5. The process of claim 4, wherein the compound of Formula II or the compound of Formula III is purified by dissolving in DMF.

6. The process of claim 5, wherein the compound of Formula II or the compound of Formula III is further isolated using an anti-solvent of a tert-butanol, water or mixtures thereof.

7. The process of claim 6, wherein the anti-solvent used for isolating Formula II is a mixture of tert-butanol and water at a ratio of 1:1 (v/v).

8. The process of claim 6, wherein the anti-solvent used for isolating compound of Formula III is water.

9. The process of claim 8, wherein the Formula IV is purified using water.

10. The process of claim 9, wherein the Formula IV is further isolated using an anti-solvent of DMF.

11. The process of claim 10, wherein the organic solvent of step (a) is DMF.

12. The process of claim 11, wherein the halogenating agent of step (b) is an N-chlorosuccinimide.

13. The process of claim 12, wherein 12 mole equivalence of N-chlorosuccinimide and 12 mole equivalence of triphenylphosphine are used for 1 mole equivalence of the compound of Formula I.

14. (canceled)

15. The process of claim 13, wherein the reaction of step (b) is carried out at temperature from 50 to 55° C.

16. (canceled)

17. The process of claim 15, wherein the reaction step (b) is carried out in 5 to 7 hours.

18. The process of claim 17, wherein the solution of the compound of Formula I is dried.

19. The process of claim 18, wherein the solution of the compound of Formula I is dried by azeotropic distillation using toluene.

20. (canceled)

21. The process of claim 19, wherein the moisture content of the solution of the compound of Formula I less than 1.0%.

22. The process of claim 21, wherein the pH of the solution of step (b) is adjusted to a pH of a range from 9 to 10 using sodium methoxide in methanol solution.

23. (canceled)

24. The process of claim 23, wherein 25 mole equivalence of 3-mercaptopropionic acid with respect to Formula II is used.

25. The process of claim 24, wherein the organic solvent of step (c) is acetonitrile.

26. The process of claim 25, wherein the inorganic base of step (c) is potassium hydroxide.

27. The process of claim 26, wherein the water is 1.5:1 ratio volume water per volume of the compound of Formula II.

28. The process of claim 27, wherein the time interval for addition of water to step (c) is after 1 to 3 hours of heating the reaction mixture to 50 to 55° C.

29. (canceled)

30. The process of claim 28, wherein the sodium exchange agent is sodium-2-ethyl hexanoate.

31. A process for preparing sugammadex acid of Formula III comprising the steps of:
a. providing a solution comprising a compound of Formula I and an organic solvent;
b. reacting the solution of step (a) with a halogenating agent and triphenylphosphine to obtain a compound of Formula II, wherein X is Cl (the compound of Formula II-a); 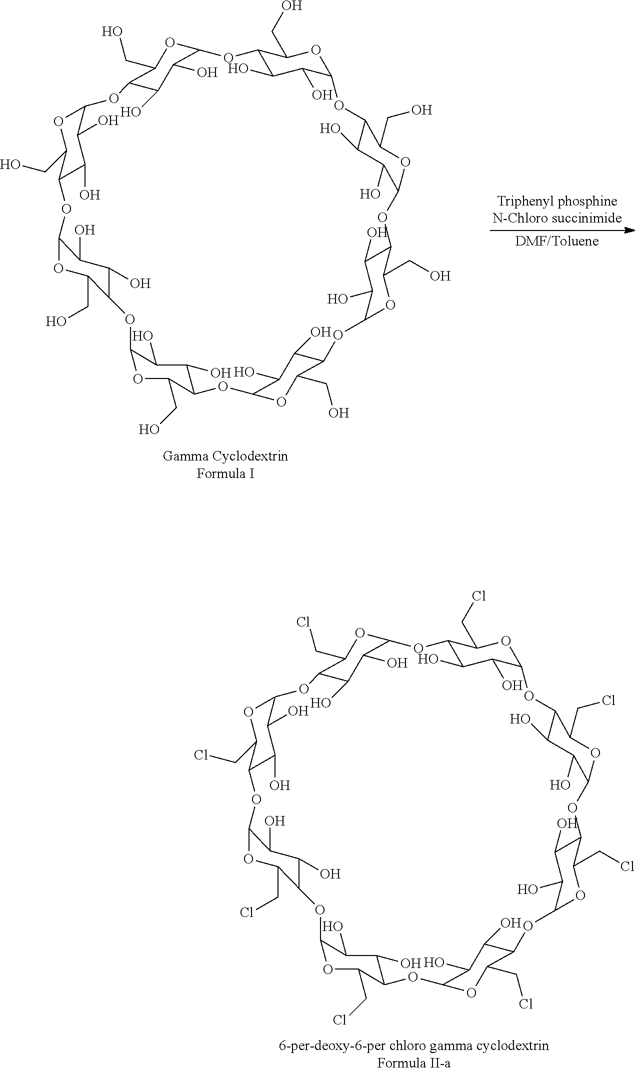 [SMILES: OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O ; OC1C2OC(CCl)C(OC3OC(CCl)C(OC4OC(CCl)C(OC5OC(CCl)C(OC6OC(CCl)C(OC7OC(CCl)C(OC8OC(CCl)C(OC9OC(CCl)C(O2)C(O)C9O)C(O)C8O)C(O)C7O)C(O)C6O)C(O)C5O)C(O)C4O)C(O)C3O)C1O]
c. reacting the compound of Formula II-a with 3-mercaptopropionic acid in the presence of an organic solvent, an inorganic base, and water followed by acidification to obtain a compound of Formula III; and 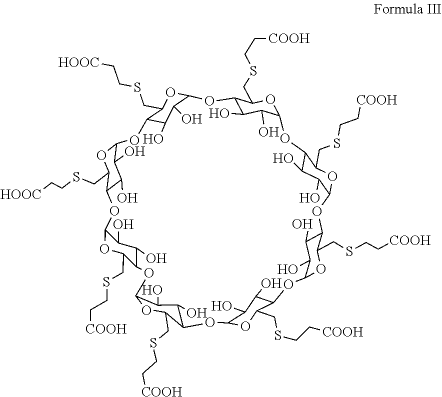 [SMILES: O=C(O)CCSCC1OC2OC3C(CSCCC(=O)O)OC(OC4C(CSCCC(=O)O)OC(OC5C(CSCCC(=O)O)OC(OC6C(CSCCC(=O)O)OC(OC7C(CSCCC(=O)O)OC(OC8C(CSCCC(=O)O)OC(OC9C(CSCCC(=O)O)OC(OC1C(O)C2O)C(O)C9O)C(O)C8O)C(O)C7O)C(O)C6O)C(O)C5O)C(O)C4O)C(O)C3O]
d. treating the compound of Formula III with a sodium exchange agent in presence of water to form a compound of Formula IV; 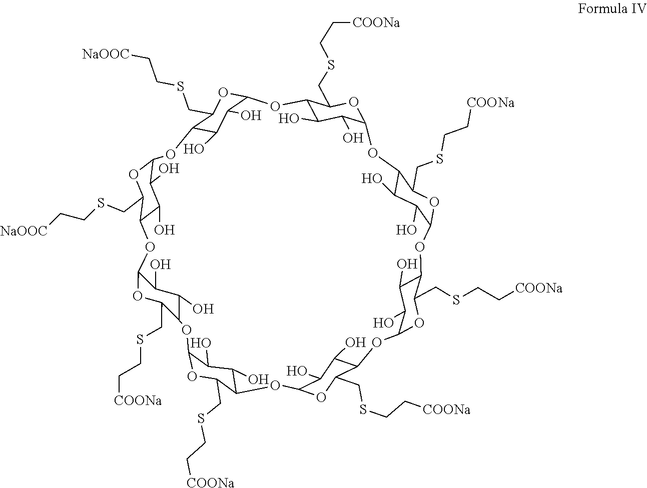
and wherein:
i. the compound of Formula II-a and the compound of Formula III are purified by dissolving in DMF;
ii. the compound of Formula II is further isolated using a mixture of tert-butanol and water at a ratio of 1:1 (v/v);
iii. the anti-solvent used for isolating compound of Formula III is water;
iv. the compound of Formula IV is purified using water;
v. the compound of Formula IV is further isolated using an anti-solvent of DMF;
vi. the halogenating agent of step (b) is an N-chlorosuccinimide;
vii. twelve mole equivalence of N-chlorosuccinimide and 12 mole equivalence of triphenylphosphine are used for 1 mole equivalence of the compound of Formula I;
viii. the reaction of step (b) is carried out at temperature from 50 to 55° C.;
ix. the reaction of step (b) is carried out in 5 to 7 hours;
x. the solution of the compound of Formula I is dried by azeotropic distillation using toluene;
xi. the moisture content of the solution of the compound of Formula I is less than 1.0%;
xii. the pH of the solution of step (b) is adjusted to a pH of a range from 9 to 10 using sodium methoxide in methanol solution;
xiii. 25 mole equivalence of 3-mercaptopropionic acid with respect to Formula II is used;
xiv. the organic solvent of step (c) is acetonitrile;
xv. the inorganic base of step (c) is potassium hydroxide;
xvi. a 1.5:1 ratio volume water per volume of the compound of Formula II;
xvii. the water in step (c) is added after 1 to 3 hours of heating the reaction mixture to 50 to 55° C.;
xviii. the process of step (c) is carried out at temperature from 50 to 55° C.; and
xix. the sodium exchange agent is sodium-2-ethyl hexanoate.
